(19) United States
(12) Patent Application Publication
(10) Pub. No.: US 2001/0009601 A1
(43) Pub. Date: Jul. 26, 2001

(54) Synchronization of two or more video players

(76) Inventor: Yoshiaki Kasuya, Iruma-shi (JP)

Correspondence Address: Woodcock Washburn Kurtz, Mackiewicz & Norris LLP, One Liberty Place - 46th Floor, Philadelphia, PA, 19103, US

(21) Appl. No.: 09/758,683

(22) Filed: Jan. 11, 2001

(30) Foreign Application Priority Data
Jan. 21, 2000 (JP) 2000-012946

(51) Int. Cl. H04N 5/76; H04N 5/91; H04N 7/00

(52) U.S. Cl. 386/46; 386/66

(57) ABSTRACT

A video player system has two or more VTRs connected to respective displays for joint presentation of as many correlated pictures. For synchronizing the pictures without relying on a devoted source of reference pulses, a vertical sync pulse separator circuit is connected to each VTR for separating a series of vertical sync pulses from the video signal being recovered from the tape. A reference moment determination circuit determines a reference moment in prescribed time relationship to each vertical sync pulse of one selected series of such pulses being supplied from either of the pulse separator circuits. Connected both to the pulse separator circuits and to the reference moment determination circuit, a play synchronization circuit produces a set of phase departure signals each indicative of a phase departure, if any, of each vertical sync pulse of one series of such pulses from the reference moment determined in relation to one associated vertical sync pulse of the selected series of such pulses. The phase departure signals are delivered respectively to the capstan motor driver circuits of the VTRs, causing the same to control the capstan motor speeds until all the series of vertical sync pulses come into phase with one another.

### BACKGROUND OF THE INVENTION

This invention relates to a synchronizer for synchronous recovery of video signals from two or more video players, and to a video player system incorporating such a synchronizer in addition to two or more video players and one or more displays.

By the term “video player,” as used herein and in the claims appended hereto, is meant a player, with or without recording facilities, of any video storage media, such as those in tape form, as in the case of a video tape recorder (VTR), and in disk form, as in the case of a videodisk player as typified by a digital versatile disk (DVD) player. The invention is applicable to any such video players as well as to a system of two or more such video players together with one or more displays.

It has been known and practiced conventionally to synchronously drive two or more VTRs, for example, for simultaneous reproduction of as many correlated video signals on separate displays or on separate sections or windows of one display screen. Japanese Unexamined Patent Publication No. 52-56513 to Matsushita Electric is hereby cited as describing and claiming how to synchronize two or more video VTRs for use with video tapes having longitudinal picture and sound tracks. Essentially, it teaches to compare the phases of the vertical synchronizing pulses, included in the recovered video signals, with that of a series of reference pulses from a source external to the tapes or to the VTRs. The drive motors for the rotary drums carrying the magnetic heads, or those for the capstans, of both VTRs are controlled so as to keep the vertical sync pulses of the video signals being reproduced, in phase with the external reference pulses.

An objection to this prior art method is that it necessitates the provision of a source of accurately timed reference pulses. Such a pulse source is costly and would make the resulting synchronizer significantly more expensive than in the absence thereof.

### SUMMARY OF THE INVENTION

The present invention seeks to attain synchronous driving of two or more video players without relying on any reference signal other than the standard vertical sync pulses prerecorded on the video tapes or other storage media.

Briefly, the invention may be summarized as a synchronizer for compulsorily synchronizing a plurality of video players for simultaneous presentation of as many correlated pictures on a display or displays, each video player being for use with a video storage medium on which there is stored a video signal including a series of vertical sync pulses. The synchronizer comprises a plurality of vertical sync pulse separator circuits to be connected one to each video player for separating the series of vertical sync pulses from a video signal being recovered from the video storage medium. Connected to the pulse separator circuits is a reference moment determination circuit for determination of a reference moment in prescribed time relationship to each vertical sync pulse of one selected series of such pulses being supplied from either of the pulse separator circuits. A play synchronization circuit is connected to both of the vertical sync pulse separator circuits and the reference moment determination circuit for production of a plurality of phase departure signals each indicative of a phase departure, if any, of each vertical sync pulse of one series of such pulses from the reference moment determined in relation to one associated vertical sync pulse of the selected series of such pulses. The phase departure signals are for delivery one to each video player for causing the video players to produce the series of vertical sync pulses in phase with each other.

In order to better illustrate the principles of this invention, let us consider the simplest case of how two video players, or two series of vertical sync pulses being thereby recovered from video storage media, are synchronized according to the invention. If the first series of vertical sync pulses lag in phase behind the second series, the reference moment determination circuit will determine, in one preferred embodiment of the invention, a reference moment at the trailing edge of each pulse of the first series.

In putting the reference moment signal and the two series of vertical sync pulses, the play synchronization will then a first and a second phase departure signal for the first and the second series of vertical sync pulses. The first phase departure signal will now contain no significant pulse because the reference moment has been determined to be at the trailing edge of each vertical sync pulse of the first series. The second phase departure signal will do, however, contain a pulse having a duration in proportion to the phase departure of each vertical sync pulse of the second series. This second phase departure signal is utilized, for example, to accelerate the capstan motor of the first video player into phase with the second.

It is thus seen that the invention dispenses with a dedicated source of timing pulses for phase comparison of the two or more series of vertical sync pulses. The synchronizer according to the invention is therefore manufacturable much more inexpensively than the conventional devices incorporating such reference pulse sources.

The above and other objects, features and advantages of the invention and the manner of realizing them will become more apparent, and the invention itself will best be understood, from the following description taken together with the attached drawings showing the preferred embodiments of the invention.

### BRIEF DESCRIPTION OF THE DRAWINGS

FIG. 1 is a block diagram showing the synchronizer according to the present invention as incorporated in a two-VTR, two-display system by way of one possible application of the invention;

FIG. 2 is a schematic diagram, partly in block form, showing in more detail the two VTRs of the FIG. 1 embodiment together with the synchronizer according to the invention;

FIG. 3 is a block diagram showing those functional means in the controller of one of the two VTRs of FIG. 2 which have relevance to the synchronizer according to the invention, the controller of the other VTR being of identical design;

FIG. 4 is a block diagram showing in some more detail the synchronizer of the FIG. 1 embodiment together with those parts of the VTRs which are directly associated with the synchronizer;

FIG. 5 is a schematic electrical diagram, partly in block form, of the play synchronization circuit of the FIG. 4 synchronizer;

FIG. 6 is a schematic electrical diagram of the VTR status judgment circuit included in the FIG. 5 play synchronization circuit;

FIG. 7 is a diagram of waveforms of signals appearing in various parts of the FIG. 5 play synchronization circuit during compulsory synchronization of the two FIG. 1 VTRs in the case where no phase difference exists between the two series of vertical sync pulses from the VTRs;

FIG. 8 is a waveform diagram similar to FIG. 7 but showing the same signals in the case where the first series of vertical sync pulses, from one of the two FIG. 1 VTRs, are delayed in phase from the second series of such pulses from the other VTR;

FIG. 9 is also a waveform diagram similar to FIG. 7 but showing the same signals in the case where the second series of vertical sync pulses are delayed in phase from the first series of such pulses;

FIG. 10 is a block diagram of a three-VTR, three-display video player system employing the synchronizer according to the invention;

FIG. 11 is a somewhat more detailed block diagram of the synchronizer of the FIG. 10 embodiment, shown together with some pertinent output and input terminals of the three VTRs;

FIG. 12 is a schematic electrical diagram of the play synchronization circuit of the FIG. 11 synchronizer;

FIG. 13 is a diagram of waveforms of signals appearing in various parts of the FIG. 12 play synchronization circuit during compulsory synchronization of the three FIG. 10 VTRs in the case where no phase difference exists between the three series of vertical sync pulses from the VTRs;

FIG. 14 is a waveform diagram similar to FIG. 13 but showing the same signals in the case where the three series of vertical sync pulses, from the three FIG. 10 VTRs, all differ in phase from one another;

FIG. 15 is also a waveform diagram similar to FIG. 13 but showing the same signals in the case where a phase difference exists between the first and the third series of vertical sync pulses and where the second of the three FIG. 10 VTRs is not in play mode;

FIG. 16 is a schematic electrical diagram of a slight modification of the FIG. 5 play synchronization circuit;

FIG. 17 is a schematic electrical diagram of a slight modification of the FIG. 12 play synchronization circuit; and

FIG. 18 is a partial schematic electrical diagram of an additional slight modification of the play synchronization circuit according to the invention.

### DESCRIPTION OF THE PREFERRED EMBODIMENTS

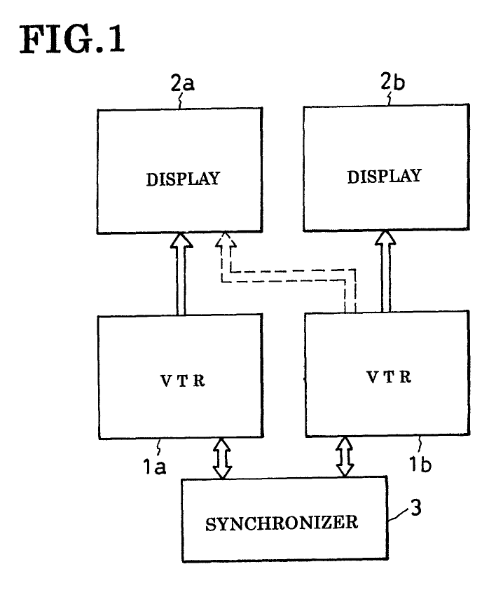

The present invention will now be described in detail as applied by way of example to the two-VTR, two-display video player system illustrated in FIG. 1. The exemplified video player system has a first 1a and a second 1b VTR of like design, a first 2a and a second 2b display which also are of identical make, and a play synchronizer 3 forming the gist of the invention. The VTRs 1a and 1b are both conventionally equipped to record composite video signals, including picture signals as well as synchronizing and blanking pulses, on magnetic tapes in cassette form, not shown in this figure, and later reproduce and send them to the displays 2a and 2b, respectively, for visual presentation of two correlated pictures. Alternatively, the video signals from both VTRs may be directed into one display, as indicated by the broken-line arrow in this figure, for reproduction of the two pictures on separate parts or windows of the same screen.

The play synchronizer 3 is shown connected to both VTRs 1a and 1b as a synchronization adapter, so to say, for compulsorily synchronizing them during playback operation by deriving the series of standard vertical sync pulses from the composite video signals being recovered from the commercially available tape cassettes by both VTRs. Relying on these vertical sync pulses, the play synchronizer 3 produces what are herein termed phase departure signals, which are directed back into both VTRs for compulsorily synchronizing them as manifested by the phasing of the all the series of vertical sync pulses.

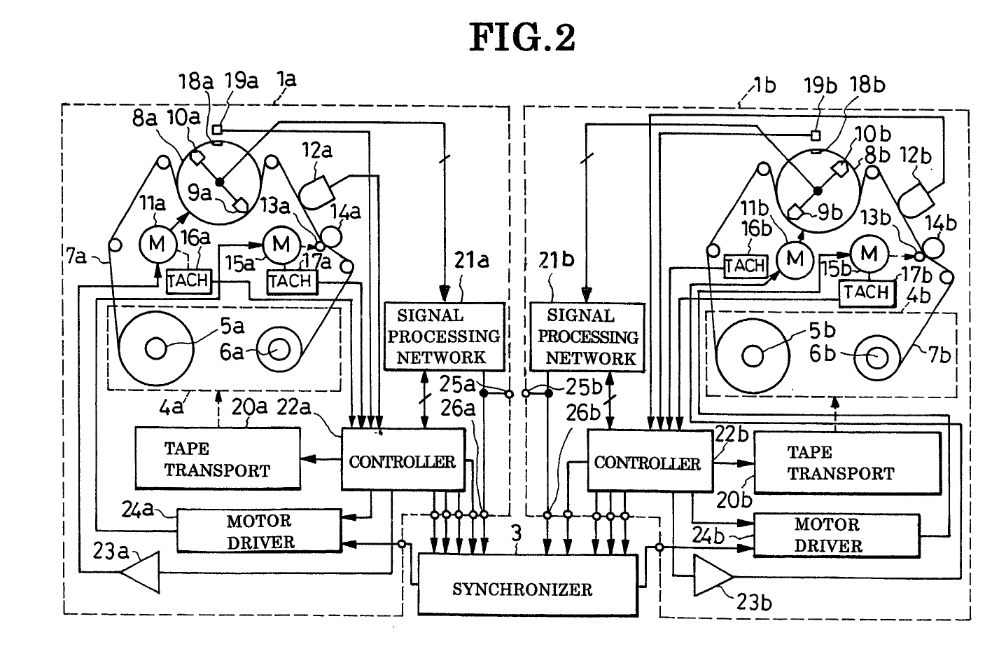

Reference may be had to FIG. 2 for more detailed study of the VTRs 1a and b. Since the two VTRs are of similar construction, like reference numerals will be used to denote like parts of both devices, as well as of the tape cassettes shown loaded therein, only with the letters a and b suffixed to such numerals to denote which VTR the parts belong to. Only the first VTR 1a will be detailed, it being understood that the same description applies to the second 1b.

Essentially constructed according to the standard VHS design, the representative VTR 1a is for use with a commercially available video tape cassette 4a wherein a length of magnetic tape 7a has its opposite extremities anchored to a pair of reels 5a and 6a to run bidirectionally therebetween. It is understood that a video signal is recorded on the tape 7a along a series of slanting tracks in conformity with for example, the NTSC or PAL standards. As is well known, the standard video signal includes the vertical sync pulses, in addition to the visual information, that are transmitted at the end of each field to keep the receiver in field-by-field synchronism with the transmitter. The picture is blanked during each vertical retrace period, when the electron beam is returned to the top of the screen at the end of one field. The tape 7a has also a control signal recorded longitudinally thereon.

Pulled out the cassette 4a and guided by guide pins, the tape 7a is wrapped a required angle over a rotary drum 8a to which a pair of magnetic read/write heads or transducers 8a and 9a are mounted in diametrically opposite positions thereon. The tape 7a is wound on the drum 8a at such an angle to its axis as to enable the transducers to trace the slanting tracks thereon. A drum motor 11a is drivingly coupled to the drum 8a. It is to be understood that the transducers 8a and 9a as well as their electrical connections are shown highly schematically in FIG. 2 by way of illustration and explanation.

Along the tape path from one reel to the other of the cassette 4a there are sequentially arranged a control head 12a, an audio head, not shown, an erase head, also not shown, and a cooperative combination of capstan 13a and pinch roller 14a. A capstan motor 15a is drivingly coupled to the capstan 13a for constant speed tape travel. Tachometers 16a and 17a are coupled to the drum motor 11a and capstan motor 15a, respectively, for feedback speed control of the motors. The drum 8a carries in a prescribed position on its circumference a part 18a to be sensed or detected by a head or detector 19a for switching between the transducers 8a and 9a.

Also included in the representative VTR 1a are a tape transport 20a, a signal processing network 21a, a controller 22a, a drum motor driver circuit 23a, and a capstan motor driver circuit 24a. Drivingly coupled to the cassette reels 5a and 6a, tape transport 20a operates under the direction of the controller 22a for causing bidirectional tape travel therebetween.

The signal processing network 21a is electrically connected to the pair of transducers 9a and 10a on the drum 8a for conventionally processing the video signals recovered from the tape and those to be recorded thereon. More specifically, the network 21a comprises a transducer switching circuit, a video amplifier, and a frequency-demodulator for processing the signals recovered, and a frequency-modulator and a recording amplifier for processing the signals to be recorded. The network 21a is shown connected to two video output terminals 25a and 26a for production of the video signals.

The controller 22a is connected to all of the control head 12a, tachometers 16a and 17a, transducer switching position detector 19a, tape transport 20a, signal processing network 21a, drum motor driver circuit 23a, and capstan motor driver circuit 24a, as well as to the play synchronizer 3 which is external to the VTR 1a. The controller 22a is per se of conventional make including a microprocessor for performing a variety of control functions.

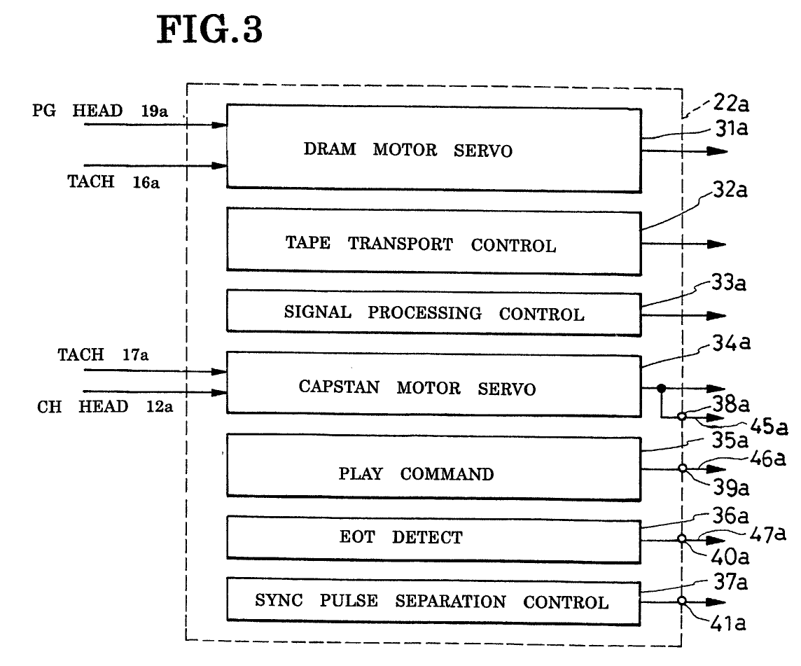

For the purposes of this invention, however, the controller 22a may be considered comprising the means depicted block-diagrammatically in FIG. 3; namely, a drum motor servo circuit 31a, a tape transport control circuit 32a, a signal processing network control circuit 33a, a capstan motor servo circuit 34a, a play command circuit 35a, a tape-end detector circuit 36a, and a sync pulse separation control circuit 37a.

The drum motor servo circuit 31a has an input connected to the transducer switching position detector 19a, and another input to the drum motor tachometer 16a, both shown in FIG. 2, for producing a control signal for the drum motor 11a in response to the outputs therefrom. The control signal is delivered to the drum motor driver circuit 23a, FIG. 2.

The tape transport control circuit 32a controls the tape transport 20a, FIG. 2. The signal processing network control circuit 33a controls the signal processing network 21a, FIG. 2.

The capstan motor servo circuit 34a has an input connected to the control head 12a, and another input to the tachometer 17a, both shown in FIG. 2, for producing a tape speed control signal for causing the capstan motor 15a to drive the tape 7a at a required speed. The tape speed control signal is supplied to the capstan motor driver circuit 24a, as well as to the play synchronizer 3 by way of a first controller output terminal 38a.

The play command circuit 35a responds to the actuation of a play switch, not shown, by the user by delivering a play command to the play synchronizer 3 from a second controller output terminal 39a. The play command is of course utilized internally of the VTR 1a, too, by means that are not shown because of impertinence to the invention.

The tape-end detector circuit 36a has an output connected to a third controller output terminal 40a for providing a signal indicative of whether the tape has been run to the predetermined end of the tape (EOT). The EOT signal is also delivered to the play synchronizer 3 from the third controller output terminal 40a.

The sync pulse separation control circuit 37a has an output connected to a fourth controller output terminal 41a for providing a control signal for separation of the vertical sync pulses from the recovered video signal. This control signal is also fed to the play synchronizer 3 from the fourth controller output terminal 41a.

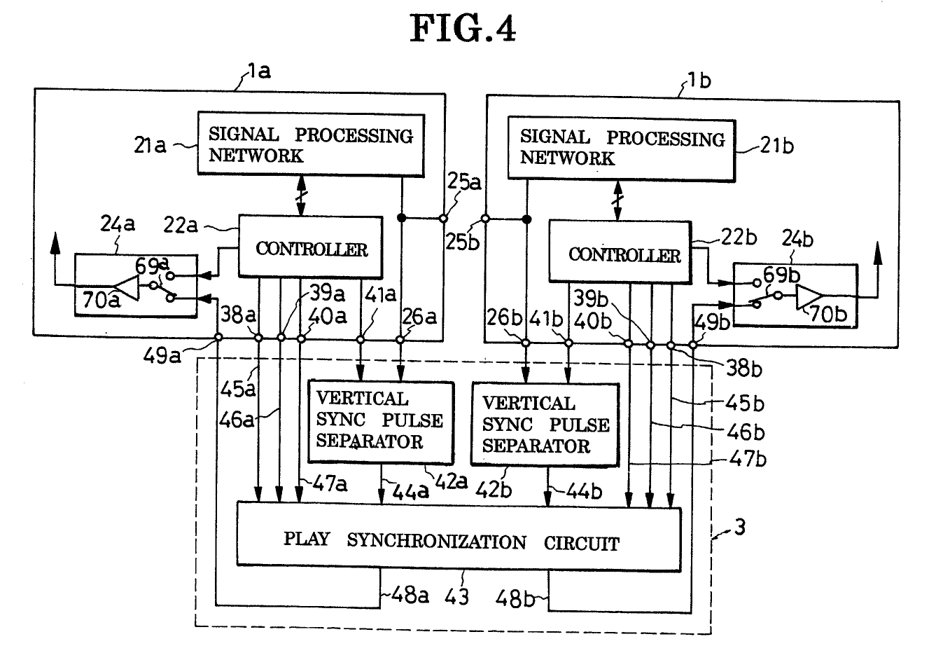

In FIG. 4 is shown in more detail the play synchronizer 3 in combination with some directly associated parts of the VTRs 1a and 1b. The play synchronizer 3 is herein shown, however, only in terms of three component circuits into which it is broadly divisible, more detailed illustration being to be presented subsequently. The three constituent circuits are two vertical sync pulse separator circuits 42a and 42b for separation of the vertical sync pulses from the video signals being recovered from the tapes in the VTRs 1a and 1b, respectively, and a play synchronization circuit 43 for production of the play synchronization signals for delivery back to the VTRs.

The first vertical sync pulse separator circuit 42a of the play synchronizer 3 has an input connected to the signal processing network 21a of the first VTR 1a via the video output 26a, and another input to the sync pulse separation control circuit 37a, FIG. 3, of the controller 22a of the first VTR via the fourth controller output terminal 41a. The second vertical sync pulse separator circuit 42b of the play synchronizer 3 has an input connected to the signal processing network 21b of the second VTR 1b via the video output 26b, and another input to the sync pulse separation control circuit of the controller 22b of the second VTR via the fourth controller output terminal 41b.

So connected to the necessary parts of the VTRs 1a and 1b, the vertical sync pulse separator circuits 42a and 42b derive the vertical sync pulses from the video signals supplied from the VTRs and deliver to the play synchronization circuit 43 one rectangular output pulse per field. The separation of sync pulses from video signals is familiar to television specialists, so that no more detailed illustration or description of the sync pulse separator circuits 42a and 42b is deemed necessary. These circuits 42a and 42b could be built into the VTRs 1a and 1b, respectively.

As indicated also in FIG. 4, the play synchronization circuit 43 has inputs connected to the two vertical sync pulse separator circuits 42a and 42b by way of lines 44a and 44b, to the first to third controller output terminals 38a, 39b and 40a of the first VTR 1a by way of lines 45a, 46a and 47a, and to the first to third controller output terminals 38b, 39b and 40b of the second VTR 1b by way of lines 45b, 46b and 47h. The play synchronization circuit 43 has two output lines 48a and 48b connected to the input terminals 49a and 49b, and thence to the capstan motor driver circuits 24a and 24b, of the VTRs 1a and 1b, respectively.

Inputting the two vertical sync pulse signals from the separator circuits 42a and 42b, the play synchronization circuit 43 operates to compare their phases one with respect to the other. For such phase comparison this circuit 43 determines a reference moment in prescribed time relationship to each pulse of one of the two input signals and provides phase departure signals indicative of a possible phase departure of each pulse of each input signal with respect to that reference moment. The phase departure signals are delivered one to each VTR for controlling the speeds of the capstan motors 15a and 15b. Since each pulse of said one input signal has no phase departure from the reference moment, only the capstan motor associated with the other input signal has its speed readjusted for synchronizing this other signal with said one.

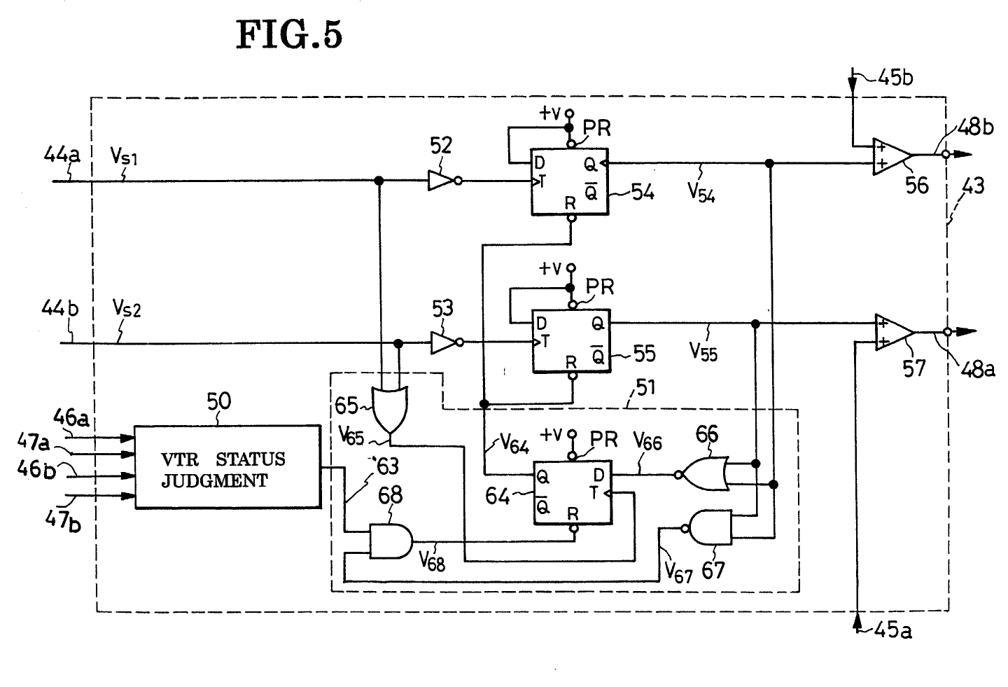

The reader's attention is now invited to FIG. 5 for closer study of the play synchronization circuit 43 of the play synchronizer 3. Broadly, the play synchronization circuit 43 comprises a VTR status judgment circuit 50 for ascertaining whether both VTRs 1a and 1b are in condition for compulsory play synchronization according to the invention, a reference moment determination circuit 51 for establishment of a reference moment with respect to each vertical sync pulse of either of the two incoming series of such pulses, two NOT circuits 52 and 53, two D flip-flops 54 and 55 as phase comparators for providing the phase departure signals, and two adders 56 and 57.

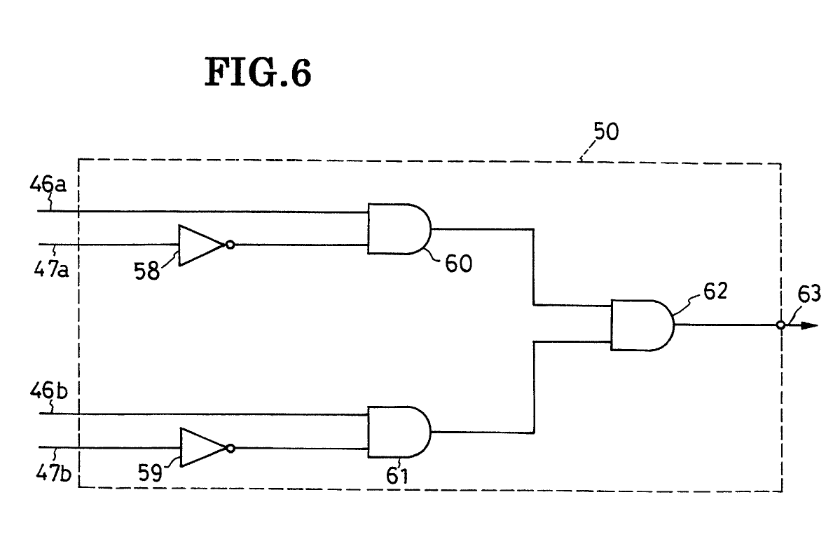

As shown in detail in FIG. 6, the VTR status judgment circuit 50 has two NOT circuits 58 and 59, and three AND gates 60, 61 and 62, although these AND gates could be input-inverting NOR gates. The first AND gate 60 has one input connected to the play command circuit 35a, FIG. 3, of the controller 22a of the first VTR 1a by way of the line 46a, and another input to the EOT detector circuit 36a, FIG. 3, of the controller 22a via the NOT circuit 58 and by way of the line 47a Likewise, the second AND gate 61 has one input connected to the equivalent of the play command circuit 35a in the controller 22b of the second VTR 1b by way of the line 46b, and another input to the equivalent of the EOT detector circuit 36a in the controller 22b via the NOT circuit 59 and by way of the line 47b.

The third AND gate 62 of the VTR status judgment circuit 50 has its two inputs connected to the first two AND gates 60 and 61. The output of the AND gate 62, and of the complete VTR status judgment circuit 50, is connected to the reference moment determination circuit 51, FIG. 5, by way of a line 63. It is thus seen that the judgment circuit 50 judges that the VTRs 1a and 1b are in condition for compulsory synchronization when both VTRs are in play mode and, at the same time, when the tapes 7a and 7b are both not driven to their ends. The judgment circuit 50 will go high when all these conditions prove to be met.

With reference back to FIG. 5 the reference moment determination circuit 51 of the play synchronization circuit 43 comprises a D flip-flop 64, a OR gate 65, a NOR gate 66, a NAND gate 67, and an AND gate 68. The OR gate 65 has its two inputs connected to the vertical sync pulse separator circuits 42a and 42b, FIG. 4, by way of the noted input lines 44a and 44b, respectively, and its output to the clock input T of the flip-flop 64. This flip-flop 64 will be hereinafter referred to as the reference moment flip-flop in contradistinction from the flip-flops 54 and 55 of the play synchronization circuit 43, which will then be referred to as the play synchronization flip-flops.

The NOR gate 66 has one input connected to the Q output of the play synchronization flip-flop 54, another input to the Q output of the other play synchronization flip-flop 55, and an output to the data input D of the reference moment flip-flop 64. The NAND gate 67 has its two inputs likewise connected respectively to the Q outputs of the play synchronization flip-flops 54 and 55. The AND gate 68 has one input connected to the output line 63 of the VTR status judgment circuit 50, another input to the NAND gate 67, and an output to the reset or clear input R of the reference moment flip-flop 64. The preset input PR of this flip-flop 64 is connected to a positive supply terminal designated +V.

The play synchronization flip-flop 54 has a trigger input T connected to the first vertical sync signal input line 44a via the NOT circuit 52, a data input D and a preset input PR both connected to a positive supply terminal +V, and a reset input R connected to the Q output of the reference moment flip-flop 64.

The other play synchronization flip-flop 55 has a trigger input T connected to the second vertical sync signal input line 44b via the NOT circuit 53, a data input D and a preset input PR both connected to a positive supply terminal +V, and a reset input R connected to the Q output of the reference moment flip-flop 64.

Both play synchronization flip-flops 54 and 55 are to be reset when their reset inputs R go low. These play synchronization flip-flops are intended as aforesaid for production of phase departure pulses for eliminating a phase differences, if any, between the two series of vertical sync pulses from the VTRs 1a and 1b. Each flip-flop will put out such phase departure pulses during the vertical retrace periods, one pulse for each field.

The adder 56 has one input connected to the Q output of the play synchronization flip-flop 54, another input connected by way of the line 45b to the equivalent of the capstan motor servo circuit 34a, FIG. 3, in the controller 22b of the second VTR 1b, and an output connected by way of the line 48b to the capstan motor driver circuit 24b, FIGS. 2 and 4, of the second VTR 1b. The capstan motor 15b is therefore driven according to the addition of the output from the capstan motor servo circuit in the second VTR controller 22b and the output from the play synchronization flip-flop 54.

The other adder 57 has one input connected to the Q output of the other play synchronization flip-flop 55, another input connected by way of the line 45a to the capstan motor servo circuit 34a, FIG. 3, of the controller 22a of the first VTR 1a , and an output connected by way of the line 48a to the capstan motor driver circuit 24a, FIGS. 2 and 4, of the first VTR 1a. The capstan motor 15a is likewise driven according to the addition of the output from the capstan motor servo circuit 34a and the output from the play synchronization flip-flop 55.

### OPERATION

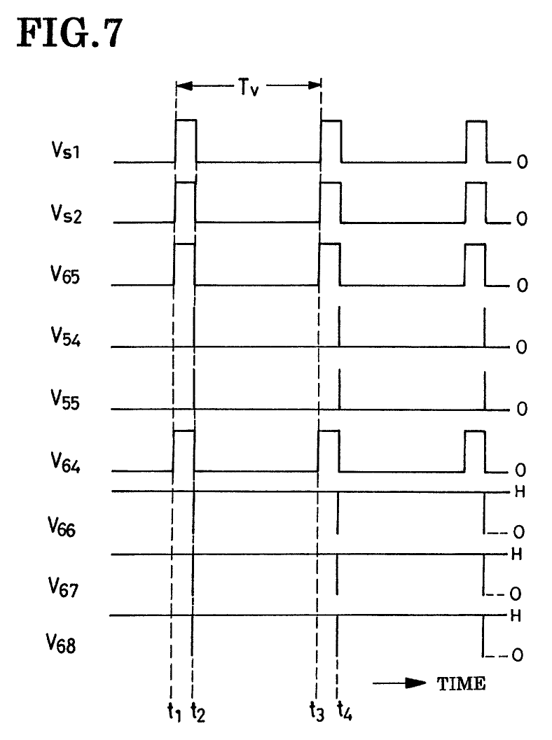

The operation of the two-VTR video player system, particularly of the play synchronizer 3, constructed as hereinbefore described with reference to FIGS. 1-6, will be best understood by referring to the waveform diagrams of FIGS. 7-9. The following indicia will be used to denote some pertinent signals associated with the play synchronizer in the following operational description of the player system:

| | |
|---|---|
| Vs₁ = | first series of vertical sync pulses from the first vertical |
| | sync pulse separator circuit 42a |
| Vs₂ = | second series of vertical sync pulses from the second verti- |
| | cal sync pulse separator circuit 42b |
| V₆₅ = | output from the OR gate 65 of the reference moment de- |
| | termination circuit 51 |
| V₅₄ = | output from the play synchronizatidn flip-flop 54, equivalent |
| | to the phase departure signal to be applied to the second |
| | VTR 1b or the phase difference between the first vertical |
| | sync pulses Vs₁ and the output V₆₄ of the flip-flop 64 |
| V₅₅ = | output from the other play synchronization flip-flop 55, |
| | equivalent to the phase departure signal to be applied to |
| | the VTR 1a or the phase difference between the second vertical |
| | sync pulses Vs₂ and the output V₆₄ of the flip-flop 64 |
| V₆₄ = | output from the reference moment flip flop 64 |
| V₆₆ = | output from the NOR gate 66 of the reference moment de- |
| | termination circuit 51 |
| V₆₇ = | output from the NAND gate 67 of the reference moment |
| | determination circuit 51 |
| V₆₈ = | output from the AND gate 68 of the reference moment de- |
| | termination circuit 51. |

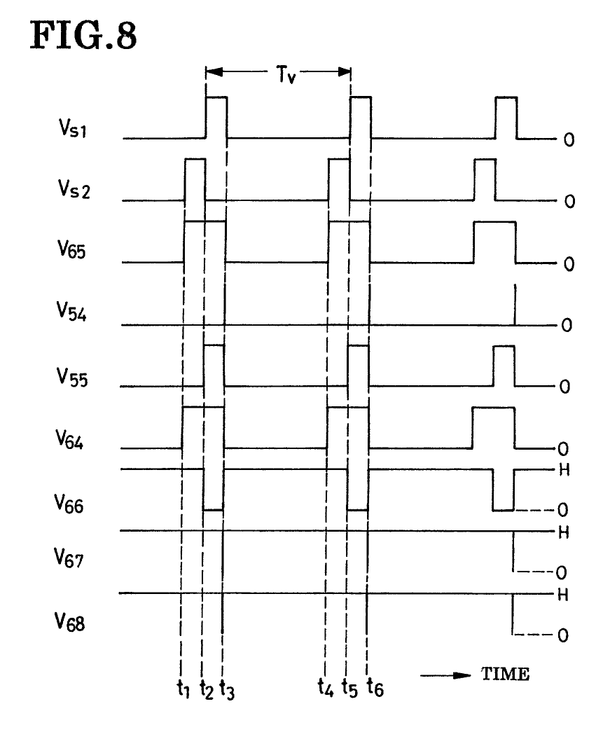

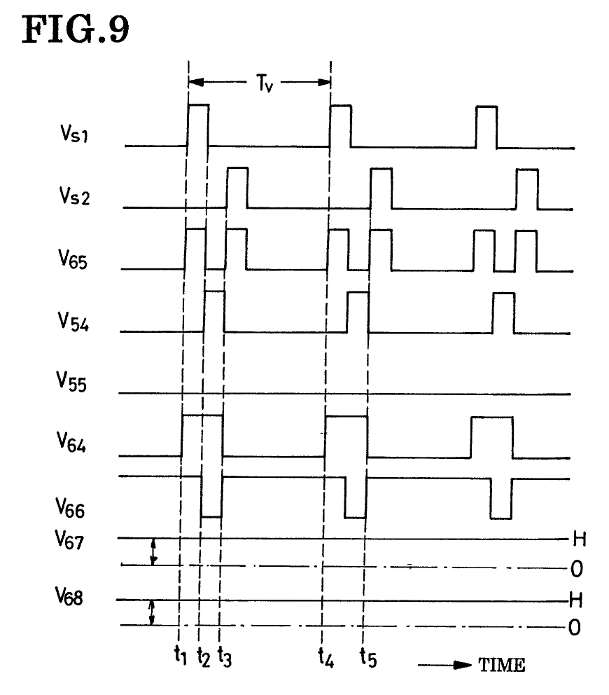

FIG. 7 represents the foregoing voltage signals appearing in the various parts of the play synchronization circuit 43, FIG. 5, when no phase difference exists between the two series of vertical sync pulses Vs₁ and Vs₂ derived from the video signals from the VTRs 1a and 1b by the sync pulse separator circuits 42a and 42b; FIG. 8 the same voltage signals when the sync pulses Vs₁ from the first VTR lag in phase behind the sync pulses Vs₂ from the second VTR; and FIG. 9 the same voltage signals when the sync pulses from the first VTR have a phase advance over those from the second VTR.

The VTR status judgment circuit 50, FIG. 6, of the play synchronization circuit 43 will go high as aforesaid when both VTRs 1a and 1b are in play mode and, at the same time, when the tapes 7a and 7b are not run to their ends. The reference moment flip-flop 64, FIG. 5, will then be not reset but operate to permit forced synchronization of the two VTRs.

On the other hand, when either or both of the VTRs 1a and 1b are not in play mode, or when the tape end is reached in either or both of these VTRs, the VTR status judgment circuit 50 will go low to indicate that the VTRs are not fit for synchronization. The AND gate 68, FIG. 5, of the reference moment determination circuit 51 will then also go low, resetting the flip-flop 64 and so making its Q output go low, too. This low output being applied to the reset inputs R of both play synchronization flip-flops 54 and 55, the play synchronization circuit 43 will not operate.

Incidentally, in the FIG. 5 play synchronization circuit 43, the NAND gate 67 will go low when both flip-flops 54 and 55 go high. The AND gate 68 will then also go low, resetting the reference moment flip-flop 64. The play synchronization flip-flops 54 and 55 will be thereby reset in turn.

Let us now assume that the VTRs 1a and 1b are now in condition for compulsory synchronization according to the invention. Supplied from the vertical sync pulse separator circuits 42a and 42b, FIG. 4, over their output lines 44a and 44b, the sync pulses Vs₁ and Vs₂ will be inverted in polarity by the NOT circuits 52 and 53 before being applied to the clock inputs of the play synchronization flip-flops 54 and 55, respectively. These flip-flops 54 and 55 will take in the high input to their data input terminals D at the moments of the trailing edges of the incoming vertical sync pulses, that is, of the rises of the outputs from the NOT circuits 52 and 53. However, being under the control of the reference moment flip-flop 64, the play synchronization flip-flops 54 and 55 will not remain set for any significant period of time, as will become better understood as the description proceeds.

If then the series of vertical sync pulses Vs₁ and Vs₂ from both VTRs 1a and 1b are in phase with each other as has been assumed above in conjunction with FIG. 7, the output pulses V₆₆ of the OR gate 65, FIG. 5, will also be in phase with these vertical sync pulses. Clocked by the leading edges of these OR gate output pulses V₆₅, the reference moment flip-flop 64 will take in the output V₆₆ from the NOR gate 66 through its data input D. The NOR gate output V₆₆ is shown in FIG. 7 to be high (H) at t₁ when the outputs V₅₄ and V₅₅ from the play synchronization flip-flops 54 and 55 are both low (0). Consequently, the output V₆₄ from the reference moment flip-flop 64 will go high at t₁ at the moment of the leading edge of the output pulse V₆₅ of the OR gate 65. Thus the play synchronization flip-flops 54 and 55 will both become operable at t₁.

Then, clocked at t₂ by the trailing edges of the vertical sync pulses Vs₁ and Vs₂, or by the rises of the outputs from the NOT circuits 52 and 53, the play synchronization flip-flops 54 and 55 will take in their data inputs D. The play synchronization flip-flop outputs V₅₄ and V₅₅ will thus go high at t₂. The output V₆₇ from the NAND gate 67 of the reference moment determination circuit 51 will go low in response to these high inputs from the play synchronization flip-flops 54 and 55, thereby causing the reference moment flip-flop 64 to be reset by the output V₆₈ from the AND gate 68.

The moment the reference moment flip-flop 64 is thus reset is the reference moment needed for play synchronization of the VTRs 1a and 1b according to the instant invention. As the reference moment flip-flop 64 is reset as above, so will be the play synchronization flip-flops 54 and 55. Therefore, as indicated in FIG. 7, the play synchronization flip-flop outputs V₅₄ and V₅₅ will go high only momentarily at t₂. It will also be noted from FIG. 7 that the NAND gate output V₆₇, AND gate output V₆₈ and NOR gate output V₆₆ will all go low momentarily at t₂. When the series of vertical sync pulses Vs₁ and Vs₂ from both VTRs 1a and 1b are in phase with each other as in FIG. 7, the play synchronization flip-flop output pulses V₅₄ and V₅₅ will be so short in duration that they are not to affect the traveling speed of the cassette tapes 7a and 7b even though they are applied via the adders 56 and 57 to the capstan motor driver circuits 24a and 24b, FIG. 4. Aside from these play synchronization pulses of negligibly short durations, the driver circuits 24a and 24b will input the capstan motor servo signals by way of the lines 45a and 45b, for causing the capstan motors 15a and 15b to be driven accordingly.

Both vertical synch pulses Vs₁ and Vs₂ recur, of course, with a cycle Tv in FIG. 7. What has happened from t₁ to t₂, as explained above, will repeat itself from t₃ to t₄ and so forth.

Let us now proceed to FIG. 8 for discussion of what occurs when the vertical sync pulses Vs₁ from the first VTR 1a slightly lag in phase from those Vs₂ from the second 1b, “slightly” because there is no time spacing between every two associated sync pulses from both VTRs. The play synchronization circuit 43 will then operate to bring the first VTR 1a into phase with the second 1b through the procedure set forth hereinbelow.

It will be observed from FIG. 8 that, in this case, each of the OR gate output pulses V₆₅ has a duration, as from t₁ to t₃, equal to the sum of the duration, as from t₂ to t₃, of one vertical sync pulse Vs₁ from one VTR and the duration, as from t₁ to t₂, of one associated vertical sync pulse Vs₂ from the other VTR. Clocked by the leading edge of each such OR gate output pulse V₅₅, the reference moment flip-flop 64 will go high at t₁, enabling the play synchronization flip-flops 54 and 55.

So enabled, the play synchronization flip-flop 55 will first go high at t₂ when the NOT circuit 53 goes high in response to the trailing edge of one vertical sync pulse Vs₂ from the second VTR. Then the other play synchronization flip-flop 54 will go high at t₃ when the NOT circuit 52 goes high in response to the trailing edge of the vertical sync pulse Vs₁ from the first VTR 1a that immediately follows the pulse Vs₂. Both play synchronization flip-flops 54 and 55 being thus high at t₃, the NAND gate 67 will go low instantly, resetting the reference moment flip-flop 64 via the AND gate 68.

The moment t₃ the reference moment flip-flop 64 is reset as above is the reference moment in the case of FIG. 8, when both play synchronization flip-flops 54 and 55 will also be reset. Their outputs V₅₄ and V₅₅ are therefore shown to go low at t₃. The play synchronization flip-flop 54 has now completed the production of a pulse of negligibly short duration, whereas the other play synchronization flip-flop 55 has produced a pulse of much longer duration, lasting from t₂ to t₃.

One cycle of operation of the play synchronization circuit 43, in response to one vertical sync pulse Vs₁ from the first VTR and one associated similar pulse Vs₂ from the second VTR, has now been completed. The next similar cycle will occur as the two associated vertical sync pulses are input from t₄ to t₆ in FIG. 8.

Each FIG. 8 output pulse V₅₄ of the play synchronization flip-flop 54 is too brief to take significant part in speed control of the magnetic tape 7b, FIG. 2, in the second VTR 1b, just as the output pulses V₅₄ and V₅₅ of both play synchronization flip-flop 54 and 55 were when both series of vertical sync pulses Vs₁ and Vs₂ were in synchronism with each other as in FIG. 7. It is the magnetic tape 7a in the first VTR 1a that needs speed readjustment for synchronous driving with the tape 7b.

To that end, each output pulse V₅₅ of the other play synchronization flip-flop output 55 has its duration determined in proportion with the phase difference between the two series of vertical sync pulses Vs₁ and Vs₂, to take active part in tape speed control in the first VTR 1a. The adder 57, FIG. 5, of the play synchronization circuit 43 will add each such play synchronization flip-flop output pulse and the capstan motor servo signal fed from the capstan motor servo circuit 34a, FIG. 3, of the first VTR controller 22a over the line 45a. The resulting output from the adder 57 will be delivered to the capstan motor driver circuit 24a, FIG. 4, of the first VTR 1a over the line 48a.

The capstan motor driver circuit 24a comprises an input selector switch 69a and an amplifier 70a. The input selector switch 69a is shown to have one fixed contact connected to the controller 22a, another fixed contact connected to the VTR output 49a and thence to the play synchronization circuit 43 by way of the line 48a, and a movable contact for selectively connecting the two fixed contacts to the amplifier 70a. FIG. 4 also shows the capstan motor driver circuit 24b of the second VTR 1b, which is of like construction.

The input selector switch 69a is to choose the play synchronization circuit 43 when the video player system is in play synchronization mode, and the VTR controller 22a when it is not. The addition of the capstan motor servo signal and the play synchronization signal is therefore amplified and applied to the capstan motor 15a in play synchronization mode, and only the capstan motor servo signal amplified and applied to the capstan motor in non-play-synchronization mode. The same holds true with the second VTR capstan motor driver circuit 24b.

Referring once again to FIG. 8, the play synchronization flip-flop output pulse V₅₅ that is produced right after each vertical sync pulse Vs₂ will be combined with the capstan motor servo signal from the first VTR controller 22a for joint delivery to the capstan motor driver circuit 24a. The first VTR capstan motor 15a will be accelerated during the t₂-t₃duration of the play synchronization flip-flop output pulse V₅₅ for bringing the first tape 7a into phase with the second tape 7b.

Possibly, the delay of the first tape 7a may not be overcome by the single output pulse V₅₅ of the play synchronization flip flop 55. Then a required number of such pulse will be produced, as from t₅ to t₆ in FIG. 8, for reaccelerating the first VTR capstan motor 15a until synchronism is attained between both series of vertical sync pulses from the VTRs 1a and 1b as in FIG. 7. Normally, the vertical sync pulses are recovered at a rate of one for each one sixtieth of a second, with errors of no more than several percent. If there is an error of 2.5 percent, for instance, then the time per field is as short as 0.000425 second. Synchronism is therefore attainable with minimal speed readjustment of one of the capstan motors 15a and 15b relative to the other.

It is also to be appreciated in connection with FIG. 8 that the t₂-t₃ or t₅-t₆ duration of each play synchronization flip-flop output pulse V₅₅ is so determined as to coincide, and not to exceed, each vertical retrace period of the video signal. The capstan motor 15a is therefore readjusted in speed without affecting the picture being exhibited on the screen.

In FIG. 9 are shown the vertical sync pulses Vs₂ from the second VTR 1b lagging in phase from those Vs₁ from the first 1a, with a time spacing between every two associated sync pulses from both VTRs. The second VTR 1b is to be accelerated into phase with the first 1b in this case, as will be detailed hereinbelow.

Inputting the two series of vertical sync pulses Vs₁ and Vs₂, the OR gate 65, FIG. 5, of the reference moment determination circuit 51 will produce the output V₆₅ composed of both series of vertical sync pulses. First clocked at t₁ by the leading edge of one of the first series of vertical sync pulses Vs₁, the reference moment flip-flop 64 will go high by taking in the NOR gate output V₆₅enabling both play synchronization flip-flops 54 and 55. Clocked at t₂ by the trailing edge of the first vertical sync pulse Vs₁, the first play synchronization flip-flop 54 will take in its data input and so go high at that moment. This high output V₅₄ will cause the NOR gate 66 to go low at t₂.

Upon appearance of the associated one of the second series of vertical sync pulses Vs₂ at t₃, the OR gate 65 will again go high, clocking the reference moment flip-flop 64. Its data input D being then low, the reference moment flip-flop 64 will go low at t₃, thereby resetting both play synchronization flip-flops 54 and 55. One output pulse from the play synchronization flip-flop 54 has now been terminated. The other play synchronization flip-flop 55 will not respond to the trailing edge of the vertical sync pulse Vs₂ appearing at t₃, staying low.

The play synchronization flip-flop output V₅₄ will be added by the adder 56 to the capstan motor servo signal fed from the second VTR controller 22b over the line 45b. The resulting adder output will be delivered over the line 48b to the second VTR capstan motor driver circuit 24b, FIG. 4, in which the adder output will be directed by the input selector switch 24b into the amplifier 70b preparatory to delivery to the second VTR capstan motor 15b. This motor will then be accelerated instantaneously to bring the lagging second VTR video tape 7b into phase with the first VTR video tape 7a. If the second series of vertical sync pulses Vs₂ does not come into synchronism with the first s₁ by the single play synchronization pulse V₅₄, the foregoing cycle of operation from t₁ to t₃ will be repeated, as from t₄ to t₅, until synchronization is achieved.

The advantages gained by this first preferred embodiment of the invention may be recapitulated as follows:

1. The two VTRs 1a and 1b can be compulsorily synchronized for playback of the correlated recordings on the two video tapes 7a and 7b by the external play synchronizer 3 of simple construction composed of only the sync pulse separator circuits 42a and 42b and the play synchronization circuit 43.

2. No dedicated reference signal is used; instead, a reference moment signal is produced from the vertical sync pulses from both VTRs in order to produce in turn a play synchronization signal for accelerating the capstan motor of the lagging VTR according to the phase difference between the two series of vertical sync pulses. The circuitry of the resulting play synchronizer is simpler and less expensive in configuration than the prior art employing a dedicated reference signal source.

3. Capstan motor speed readjustment in response to a pulse or pulses from either of the play synchronization flip-flops 54 and 55 is made during vertical retrace, so that the pictures being displayed are not affected in any way by the compulsory synchronization.

4. The play synchronization signals according to the invention are combined with the standard capstan motor servo signals prior to delivery to VTRs, in which selection is made by the input selector switches 24a and 24b between the capstan motor servo signals alone and the combination of the play synchronization signals and capstan motor servo signals. So constructed, the play synchronizer 3 lends itself to use as an external adapter of commercially available VTRs.

5. Connected in circuit with the VTRs 1a and 1b, the play synchronization circuit 43 will nevertheless operate only when the VTRs are in condition for forced play synchronization, thanks to the provision of the VTR status judgment circuit 50.

### SECOND FORM

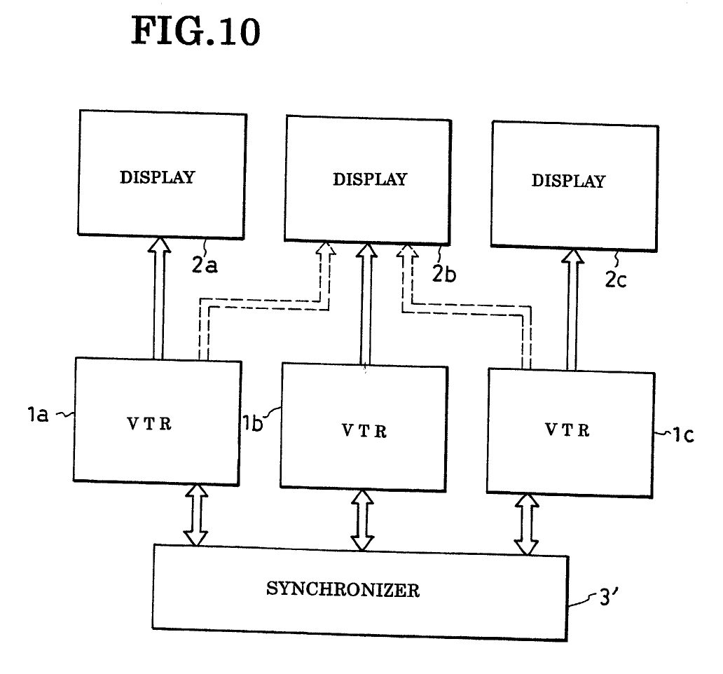

The invention is herein applied to the three-VTR, three-display video player system shown in FIG. 10. The three VTRs 1a, 1b and 1c are of identical design, the third VTR 1c being similar to the VTRs 1a and 1b shown in FIG. 2, and so are the three displays 2a, 2b and 2c The pertinent parts of the third. VTR 1c will be identified by suffixing the letter c to the reference numerals used to denote the corresponding parts of the VTRs 1a and 1b. As in the first disclosed embodiment,. the VTRs 1a-1c may be either independently coupled to the respective displays 2a-2c, as indicated by the solid lines in this figure, or to one display, as indicated by the dashed lines. At 3′ is shown a play synchronizer according to the instant invention which is adapted for use with the three VTRs 1a-1c.

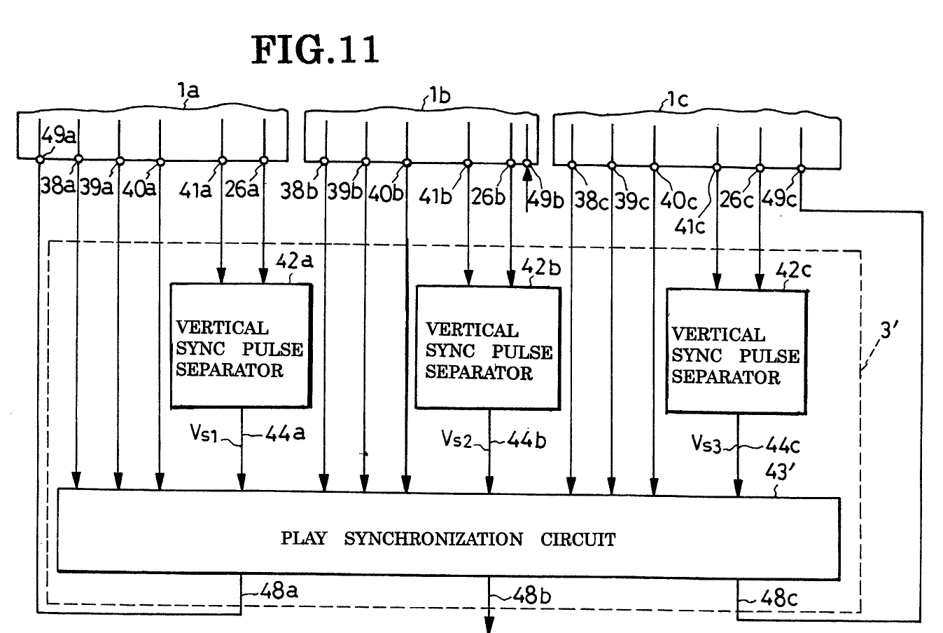

As depicted block-diagrammatically in FIG. 11, the modified play synchronizer 3′ is broadly divisible into a first 42a, a second 42b and a third 42c vertical sync pulse separator circuit for deriving the vertical sync pulses from the composite video signals recovered from the tapes by the three VTRs 1a, 1b and 1c, respectively, and a play synchronization circuit 43′ for creating play synchronization signals from the derived vertical sync pulses. The three vertical sync pulse separator circuits 42a-42c are of like configuration, the third circuit 42c being similar to the first two circuits 42a and 42b. Suffice it to say, therefore, that the third vertical sync pulse separator circuit 42c is connected to the video output terminal 26c and fourth controller output terminal 41c of the third VTR 1c for separating the vertical sync pulses Vs₃ from the third video output, and to the play synchronization circuit 3′ for delivery of the vertical sync pulses thereto.

The play synchronization circuit 43′ is designed on the same principles as the FIG. 5 play synchronization circuit 43 for production of capstan motor control signals, composed of play synchronization signals according to the invention and conventional capstan motor servo signals, which are applied to the three VTRs 1a-1c for their play synchronization. Toward this end the play synchronization circuit 43′ is connected to the vertical sync pulse separator circuits 42a-42c by way of lines 44a-44c, to the output terminals 38a, 39a, 49a and input terminal 49a of the first VTR 1a , to the output terminals 38b, 39b and 40b and input terminal 49b of the second VTR 1b, and to the output terminals 38c, 39c and 40c and input terminal 49c of the third VTR 1c. The terminals 26c, 38c-40c and 49c of the third VTR 1c correspond to the terminals 26a, 38a-40a and 49a of the first VTR 1a. Although the connection of the second output line 48b of the play synchronization circuit 3 is not clearly indicated in FIG. 11 for illustrative convenience, it is understood that the output line 48b is connected to the terminal 49b of the second VTR 1b, just as the output line 48b of the play synchronization circuit 43, FIG. 4, is shown connected to the terminal 49b of the second VTR.

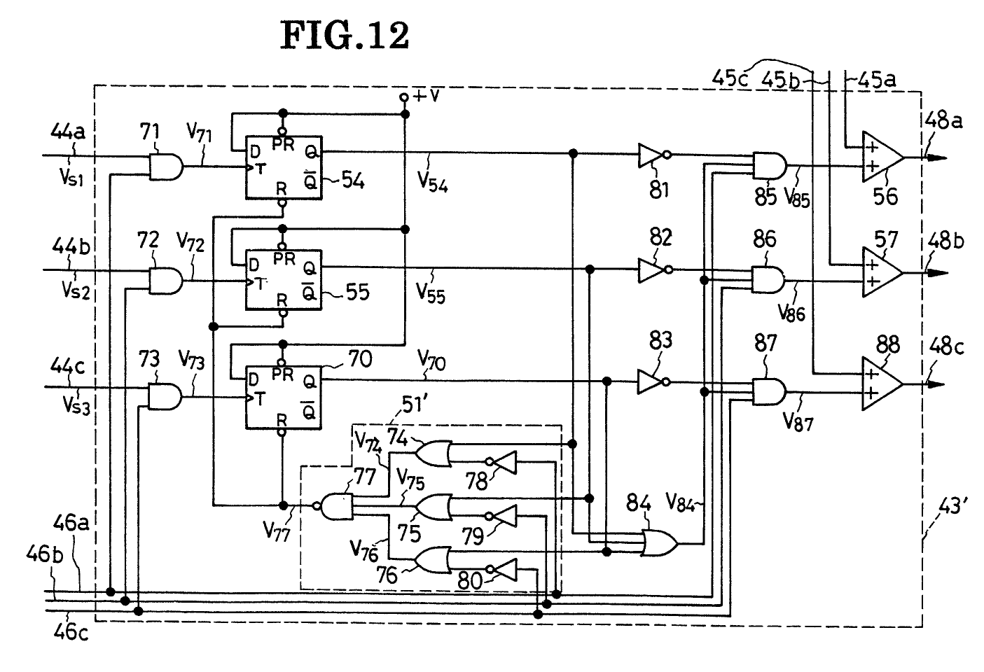

As illustrated in more detail in FIG. 12, the play synchronization circuit 3′ comprises a third D flip-flop 70 for play synchronization in addition to the two noted play synchronization flip-flops 54 and 55 of the first embodiment, a third adder 88 in addition to the two noted adders 56 and 67, three AND gates 71, 72 and 73, a reference moment determination circuit 51′ which is an adaptation of the FIG. 5 reference moment determination circuit 51 for use with three VTRs, three NOT circuits 81, 82 and 83, a three-input OR gate 84, and three AND gates 85, 86 and 87.

Instead of the VTR status judgment circuit 50, FIG. 5, of the first disclosed play synchronization circuit 43, the modified synchronization circuit 43′ has the three AND gates 71-73 having their inputs connected respectively to the vertical sync pulse separator circuits 42a-42c by way of the vertical sync pulse lines 44a-44c on the one hand and, on the other, to the play command output terminals 39a-39c, FIG. 3, of the VTRs 1a-1c by way the lines 46a-46c. Thus are the vertical sync pulses Vs₁-Vs₃ allowed through the AND gates 71-73 only when high inputs indicative of play commands are being input from the controllers of the VTRs 1a-1c. Any undesired operation of the play synchronization circuit 43′, so triggered for instance by noise, is thus precluded when the VTRs 1a-1c are in other than play mode.

The three play synchronization flip-flops 54, 55 and 70 have their clock inputs T connected to the AND gates 71-73, respectively, their data inputs D and preset inputs PR connected to a positive supply terminal +V, and their reset inputs R to the reference moment determination circuit 51′.

The reference moment determination circuit 51′ has three OR gates 74, 75 and 76 connected respectively to the Q outputs of the play synchronization flip-flops 54, 55 and 70 on the one hand and, on the other, to the play command lines 46a-46c via NOT circuits 78, 79 and 80. An NAND gate 77, another component of the reference moment determination circuit 51′, have inputs connected to the three OR gates 74-76, and an output connected as aforesaid to the reset inputs R of the play synchronization flip-flops 54, 55 and 70. Alternatively, the OR gates 74-76 could be coupled directly to the flip-flops 54, 55 and 70.

The OR gate 84 has its three inputs connected respectively to the Q outputs of the play synchronization flip-flops 54, 55 and 70. The output of this OR gate 84 is connected to all of the three-input AND gates 85-87, the other inputs of which are connected respectively to the Q outputs of the play synchronization flip-flops 54, 55 and 70 via the NOT circuits 81-83, and to the play command lines 46a-46c. The AND gates 85-87 could be connected directly to the inverting outputs of the play synchronization flip-flops 54, 55 and 70.

The first adder 56 has one input connected to the capstan motor servo line 45a of the first VTR 1a, another input to the AND gate 85, and an output to the line 48a leading to the input terminal 49a of the capstan motor driver circuit 24a, FIG. 4, of the first VTR. The second adder 57 has one input connected to the capstan motor servo line 45b of the second VTR 1b, another input to the AND gate 86, and an output to the line 48b leading to the input terminal 49b of the capstan motor driver circuit 24b of the second VTR. The third adder 88 has one input connected to the capstan motor servo line 45c of the third VTR 1c, another input to the AND gate 87, and an output to the line 48c leading to the input terminal 49c of the capstan motor driver circuit of the third VTR. Thus the adders 56-58 provide additions of the standard capstan motor servo signals from the VTRs controllers and the play synchronization signals from the AND gates 85-87, for delivery to the capstan motor driver circuits of the VTRs 1a-1c.

### OPERATION OF SECOND FORM

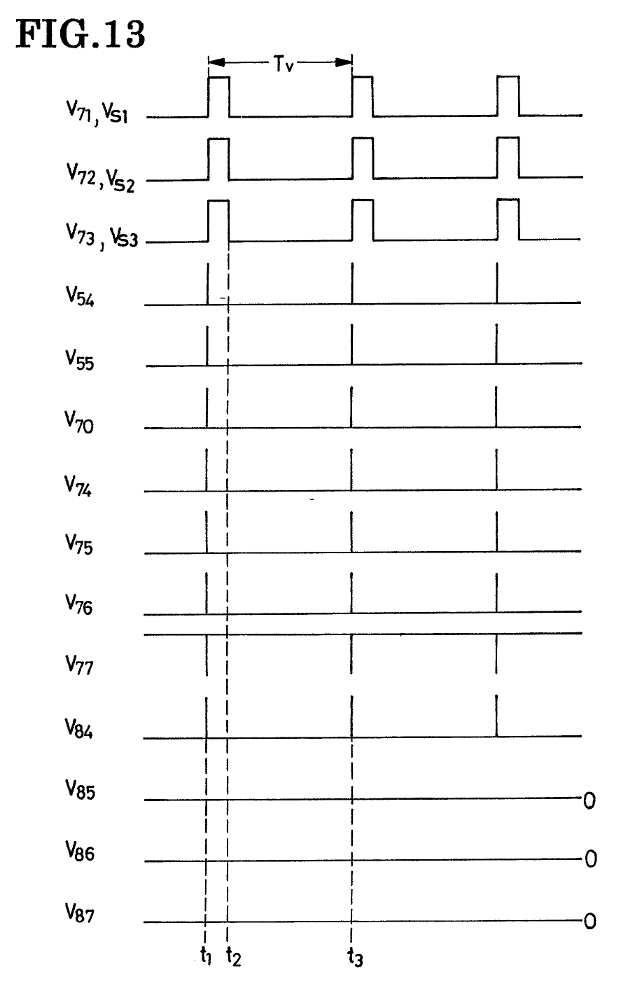

Reference may be had to the waveform diagrams of FIGS. 13-15 for the following discussion of the operation of the three-VTR video player system of FIGS. 10-12. The following indicia will be used to denote the pertinent signals appearing in various parts of the FIG. 12 play synchronization circuit 43′ in the following operational description:

| | |
|---|---|
| V₇₁ = | Vs₁ = first series vertical sync pulses from the first verti |
| | cal sync pulse separator circuit 42 a |
| V₇₂ = | Vs₂ = second series of vertical sync pulses from the sec- |
| | ond vertical sync pulse separator circuit 42 b |
| V₇₃ = | Vs₃ = third series of vertical sync pulses from the third |
| | vertical sync pulse separator 42 c |
| V₅₄ = | output from the first play synchronization flip-flop 54 |
| V₅₅ = | output from the second play synchronization flip-flop 55 |
| V₇₀ = | output from the third play synchronization flip flop 70 |
| V₇₄ = | output from the first OR gate 74 of the reference moment |
| | determination circuit 51′ |
| V₇₅ = | output from the second OR gate 75 of the reference mo- |
| | ment determination circuit 51′ |
| V₇₆ = | output from the third OR gate 76 of the reference moment |
| | determination circuit 51′ |
| V₇₇ = | output from the NAND gate 77 of the reference moment |
| | determination circuit 51′ |
| V₈₄ = | output from the OR gate 84 |
| V₈₅ = | output from the AND gate 85 |
| V₈₆ = | output from the AND gate 86 |
| V₈₇ = | output from the AND gate 87. |

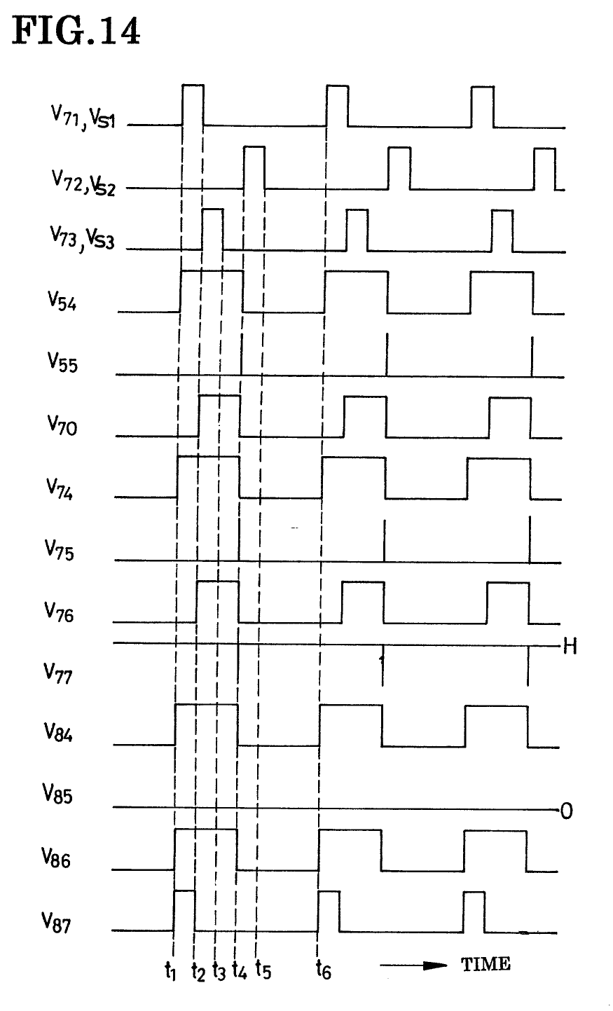

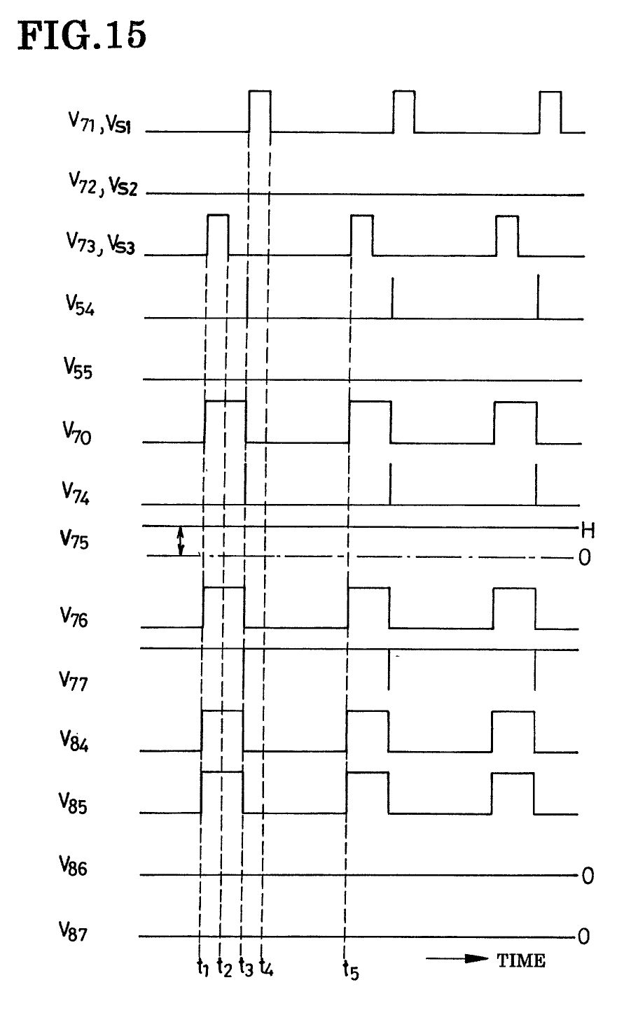

FIG. 13 represents the foregoing voltage signals when the three series of vertical sync pulses Vs₁, Vs₂ and Vs₃ from the three VTRs 1a, 1b and 1c are all in synchronism with one another; FIG. 14 the same voltage signals when the sync pulses Vs₁ from the first VTR 1a are advanced in phase over those from the other VTRs 1b and 1c; and FIG. 15 the same voltage signals when the sync pulses Vs₃ from the third VTR 1c has a phase advance over those Vs₁ from the first 1a, with the second VTR 1b being in stop mode.

The three play synchronization flip-flops 54, 55 and 70, FIG. 12, of the play synchronization circuit 43′ will all be clocked by the three series of vertical sync pulses Vs₁-Vs₃ if all the VTRs 1a-1c are in play mode. Let us assume that all these series of vertical sync pulses are in phase as in FIG. 13. The Q outputs V₅₄, V₅₅, and V₇₀ from the flip-flops 54, 55 and 70 will all go high as at t₁ in FIG. 13 in response to the leading edges of each vertical sync pulse of each series. These high outputs from cause the three OR gates 74-76 of the reference moment determination circuit 51′ go high, too, thereby making the NAND gate 77 go low. The low output V₇₇ will reset all the three flip-flops 54, 55 and 70 instantly after they have gone high at t₁ as above. As the flip-flop outputs V₅₄, V₅₅ and V₇₀ become low again after the instantaneous high state at t₁, the output V₇₇ from the reference moment determination circuit 51′ will become high again immediately after that moment, enabling the flip-flops 54, 55 and 70.

The OR gate 84 will also respond to the instantaneous pulses from all the flip-flops 54, 55 and 70, itself instantaneously going high at t₁, as indicated at V₈₄ in FIG. 13. Although this instantaneous output pulse of the OR gate 84 is applied to the three AND gates 85-87, these AND gates will also input the inversions, by the NOT circuits 81-83, of the flip-flop output pulses V₅₄, V₅₅ and V₇₀ at t₁, so that the AND gate outputs V₈₅-V₈₇ will remain low.

No play synchronization pulses will thus be input to the adders 56-58. Directed from the three VTR controllers over the lines 45a-45c, the capstan motor servo signals only will be fed over the play synchronization circuit output lines 48a-48c to the capstan motor driver circuits of the three VTRs. No phase readjustment will occur in the VTRs in response to the vertical sync pulses input to the phase synchronization circuit 43′ from t₁ to t₂.

The play synchronization circuit 43′ will repeat the foregoing cycle of operation in response to each set of three vertical sync pulses incoming at the cycle Tv. No phase readjustment will occur, either, as long as each such set of pulses remain in phase as in FIG. 13.

In FIG. 14 are shown the first series of vertical sync pulses Vs₁ as having a phase advance over the other two series Vs₂ and Vs₃; the second series of vertical sync pulses Vs₂ as having a phase lag from the other two Vs₁ and Vs₃; and the third series of vertical sync pulses Vs₃ as having a phase lag from the first Vs₁ and a phase advance over the second Vs₂. The first pulse of the first series of vertical sync pulses Vs₁ is shown to appear from t₁ to t₂, the first pulse of the second series Vs₂ from t₄ to t₅, and the first pulse of the third series Vs₃ from t₂ to t₃.

In that case, out of the three flip-flops 54, 55 and 70, the first flip-flop 54 will first go high at t₁ in response to the leading edge of one of the first series of vertical sync pulse Vs₁. Then the third flip-flop 70 will go high at t₂ in response to the leading edge of one of the third series of vertical sync pulses Vs₃. Finally, the second flip-flop 55 will go high at t₄ in response to the leading edge of one of the second series of vertical sync pulses Vs₂.

At t₄, therefore, the three flip-flops 54, 55 and 70 will all be high, making the NAND gate 77 of the reference moment determination circuit 51′ go low. All the flip-flops 54, 55 and 70 will in turn be reset by this low output from the circuit 51′, themselves going low after t₄. Then the NAND gate 77 will go high again after having been momentarily low at t₄ and so enable the flip-flops 54, 55 and 70 for the vertical sync pulses to be supplied subsequently.

A closer observation of FIG. 14 will reveal that the pulse thus produced by the first flip-flop 54 rises at t₂ with the rise of one first vertical sync pulse Vs₁ and decays at t₄ with the rise of one second vertical sync pulse Vs₂. The output pulse of the second flip-flop 55 rises and decays almost concurrently at t₄. The output pulse of the third flip-flop 70 rises at t₂ with the rise of one third vertical sync pulse Vs₃ and decays also at t₄.

In short the pulses issuing from the flip-flops 54, 55 and 70 during the t₁-t₄ period have durations equal to the time differences between the leading edge, at t₄ (reference moment in this case), of one second vertical sync pulses Vs₂, which is the most delayed, and the leading edges, at t₁, t₄ and t₂, respectively, of the three associated vertical sync pulses Vs₁-Vs₃. Thus, as in the previous embodiment of the invention, the reference moment determination circuit 51′ functions to provide a series of reference moments, and the flip-flops 54, 55 and 70 to ascertain the phase departures of the three series of vertical sync pulses with respect to the reference moments.

Inputting the three flip-flop outputs V₅₄, V₅₅ and V₇₀, the OR gate 84 will be high from t₁ to t₄ in FIG. 14. The inversions, by the NOT circuits 81-83, of the flip-flop outputs V₅₄, V₅₅ and V₇₀ will be allowed through the AND gates 85-87 only during the t₁-t₄ period. The resulting output from the first AND gate 85 will be low during this period, so that no speed change of the capstan motor will be made for synchronization purposes in the first VTR 1a, which is now assumed to be most advanced in the phase of the vertical sync pulses. The capstan motor of the first VTR 1a will, instead, be controlled solely by the capstan motor servo signal fed from the first VTR controller.

Since the inversion of the second flip-flop output V₅₅ during the t₁-t₄ period is high except at t₄, the resulting output from the second AND gate 86 will be high throughout the period. Added to the capstan motor servo signal from the second VTR controller at the second adder 57, the high output from the second AND gate 86 will cause a corresponding acceleration of the capstan motor of the second VTR 1b, which is now assumed to be most delayed, in order to bring the second series of vertical sync pulses Vs₂ into phase with the first Vs₁.

The inversion of the third flip-flop output V₇₀ is high from t₁ to t₂ and low from t₂ to t₄, the resulting output from the third AND gate 87 will be high from t₁ to t₂. This third AND gate output V₈₇ will be added to the capstan motor servo signal from the third VTR controller at the third adder 88 for delivery to the third VTR capstan motor driver circuit. The third VTR capstan motor will be accelerated from t₁ to t₂ for bringing the third series of vertical sync pulses Vs₃ into phase with the first Vs₁.

The three VTRs 1a-1c may, or may not, be synchronized solely by the foregoing cycle of operation taking place from t₁ to t₄ in FIG. 14. The same cycle will be repeated as required after t₅ until synchronization is achieved.

FIG. 15 has been drawn on the assumption that only the first and third VTRs 1a and 1c are in play mode and that the first series of vertical sync pulses Vs₁ lag in phase behind the third series of vertical sync pulses Vs₃. In this case the play synchronizer 3′ is required to accelerate the first VTR 1a into synchronism with the third 1c.

The third flip-flop 70 will go high upon appearance of one third vertical sync pulse Vs₃ at t₁, causing the third OR gate 76 of the reference moment determination circuit 51′ to go high at that moment. The first flip-flop 54 will go high upon appearance of one first vertical sync pulse Vs₁ at t₃, likewise causing the first OR gate 74 of the reference moment determination circuit 51′ to go high at that moment. Since the second VTR 1b is now not in play mode, the second play command line 46b will be low, so that the NOT circuit 79 and therefore the second OR gate 75 will both be high.

At t₃, therefore, all the inputs to the NAND gate 77 of the reference moment determination circuit 51′ will become high, causing the NAND gate to go low. All the flip-flops 54, 55 and 70 will thus be reset t₃. The first and third flip-flops 54 and 70 will then go low, whereas the second flip-flop 55 has been low. The OR gate 84 will therefore be high from t₁ to t₃, and so will be the AND gate 85. The high output V₈₅ from the AND gate 85 will be added by the adder 56 to the first VTR capstan motor servo signal, and the resulting adder output delivered to the first VTR capstan motor driver circuit for accelerating the first VTR capstan motor. Here again the same cycle of operation will be repeated after t₅ in FIG. 15 until the first 1a and the third 1c VTRs become synchronized.

If, contrary to the showing of FIG. 15, the second VTR 1b were in play mode, too, the second series of vertical sync pulses Vs₂ would be allowed through the AND gate 72. Depending upon the phase relations of the second series of vertical sync pulses Vs₂ to the other two series of such pulses Vs₁ and VS₃, they will undergo a different procedure for synchronization therewith. Details of such a synchronization procedure are considered self-evident from the foregoing description of FIGS. 13-15.

It is now clear that the present invention is equally well applicable to both two- and three-VTR display systems. In the case of the three-VTR system of FIGS. 10-12, too, a reference moment is set up in relation to the most delayed one of each set of three associated vertical sync pulses. The phase relations of each set of vertical sync pulses relative to the reference moment are determined by the flip-flops 54, 55 and 70, and capstan motor acceleration pulses are produced accordingly. The three series of vertical sync pulses are forced into exact synchronization by use of simple and inexpensive electronics comprising the flip-flops and logic circuits.

The advantages gained by this three-VTR system are akin to those set forth in connection with the two-VTR system. Additionally, any two of the three VTRs, in addition to all three, may be played synchronously.

### THIRD FORM

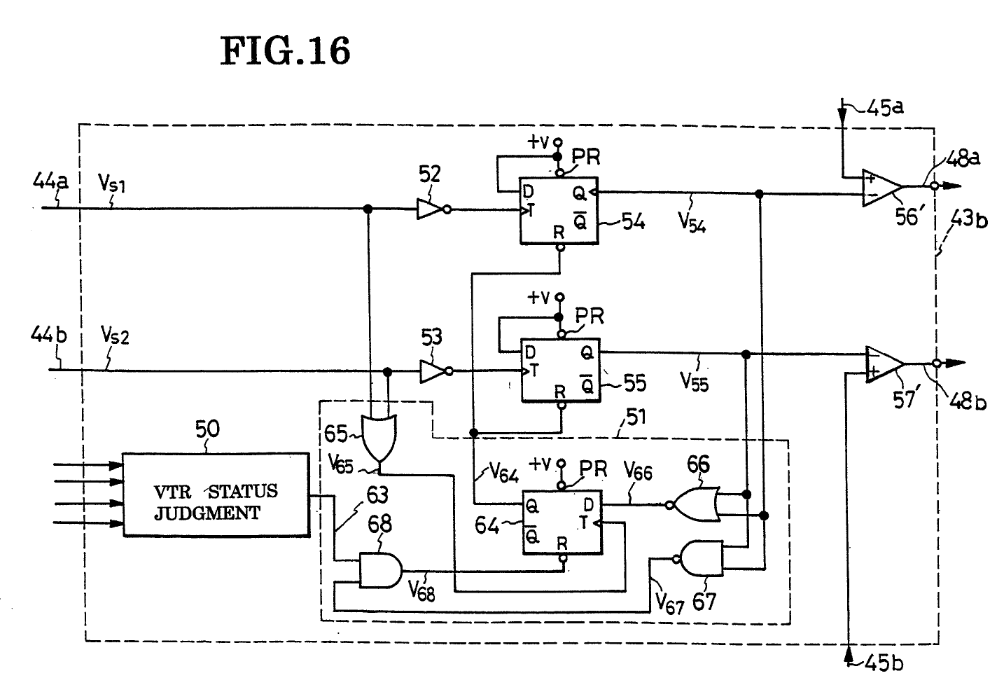

FIG. 16 shows a slight modification 43b of the two-VTR play synchronization circuit 43, FIG. 5. The modified play synchronization circuit 43b features subtracters 56′ and 57′ employed in lieu of the adders 56 and 56 of the circuit 43. The subtracters 56′ and 57′ have positive inputs connected to the first and the second VTR capstan motor servo lines 45a and 45b, negative inputs connected to the Q outputs of the flip-flops 54 and 55, and outputs connected by way of the lines 48a and 48b to the first and the second VTR capstan motor driver circuits 24a and 24b, FIG. 4, respectively. The modified play synchronization circuit 43b is analogous with the FIG. 5 circuit 43 in the other details of construction.

In operation, if the two series of vertical sync pulses Vs₁ and Vs₂ have the phase relationship depicted in FIG. 8, for instance, then the output V₅₅ from the second flip-flop 55 will be subtracted from the second VTR capstan motor servo signal. The result will be the deceleration of the second VTR capstan motor, until the second series of vertical sync pulses Vs₂ are delayed into phase with the first Vs₁.

### FOURTH FORM

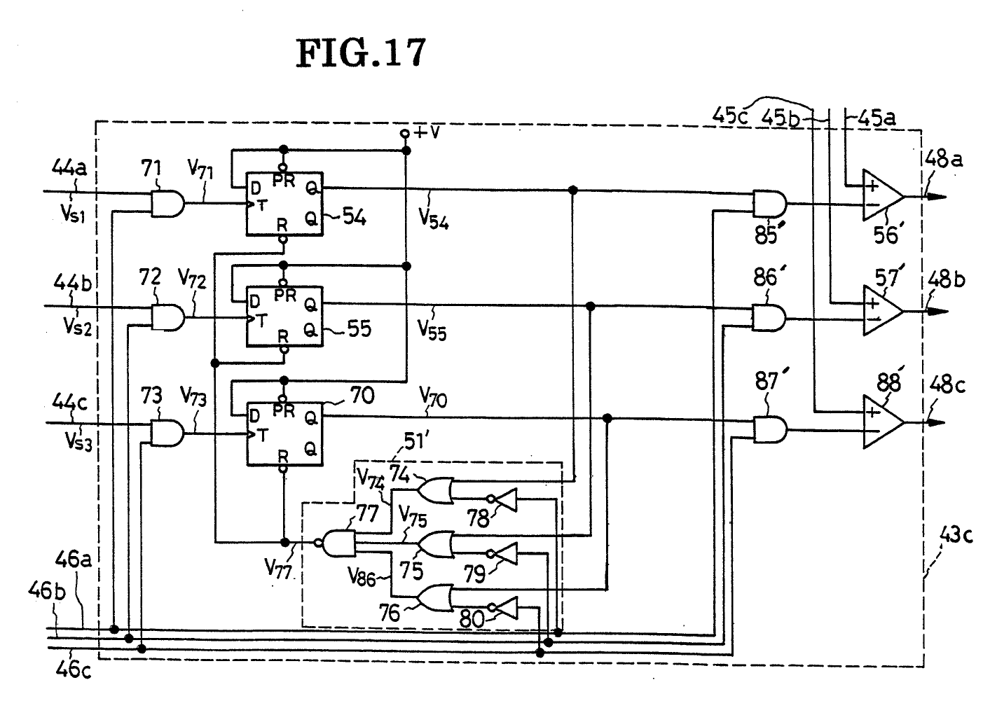

The three-VTR play synchronization circuit 43′ of FIG. 12 is likewise modifiable as in FIG. 17. The modified play synchronization circuit 43c incorporates three subtracters 56′, 57′ and 88′ in places of the adders 56, 57 and 88 of the FIG. 12 circuit 43′. The subtracters 56′, 57′ and 88′ have positive inputs connected to the VTR capstan motor servo lines 45a, 45b and 45c, negative inputs connected to the Q outputs of the flip-flops 54, 55 and 70 via two-input AND gates 85′, 86′ and 87′ only, and outputs connected by way of the lines 48a, 48b and 48c to the three capstan motor driver circuits, respectively. The AND gates 85′-87′ have their other inputs connected to the play command lines 46a-46c, respectively. The other details of construction are as previously set forth with reference to FIG. 12.

If the three series of vertical sync pulses Vs₁- Vs₃ have the phase relationship of FIG. 14, for instance, the outputs V₅₄ and V₇₀ from the flip-flops 54 and 70 will be subtracted from the first and the third VTR capstan motor servo signals on the lines 45a and 45c. The first and the third VTR capstan motors will then be decelerated until the first and the third series of vertical sync pulses Vs₁ and Vs₃ are delayed into phase with the second Vs₂ which have been most delayed.

### FIFTH FORM

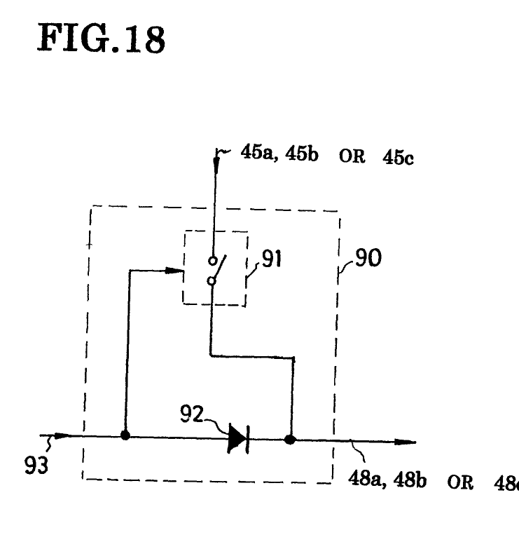

The adders 56 and 57 of FIG. 5 and adders 56, 57 and 88 of FIG. 12 may all be each replaced by a signal selector circuit shown in FIG. 18 and therein generally designated 90. The representative signal selector circuit 90 is a simple combination of an on-off switch 91 and a reverse-blocking diode 92. The switch 91 is connected between the capstan motor servo line 45a, 45b or 45c and the play synchronization circuit output line 48a, 48b or 48c. Preferably a transistor or like electronic switch, the switch 91 is normally closed, opening in response to a pulse on the play synchronization signal line 93, which in fact is the output line of the flip-flop 54 or 55 in FIG. 5 or of the AND gate 85, 86 and 87 in FIG. 12. The play synchronization signal line 93 is connected to the play synchronization circuit output line 48a, 48b or 48c via the diode 92.

The capstan motor servo signal will travel freely through the signal selector circuit 90 when the play synchronization circuit 43 or 43′ is producing no pulses, for constant speed servo control of the associated capstan motor. The switch 91 will open in response to, say, the t₂-t₃ pulse V₅₅, FIG. 8, from the flip-flop 55, FIG. 5, so that only this pulse will be allowed through the signal selector circuit 90 for accelerating the second VTR capstan motor. In use of this signal selector circuit 90 the voltage amplitude of the play synchronization pulses on the line 93 may be made higher than the maximum voltage of the capstan motor servo signal on the line 45a, 45b or 45c.

The subtracters 56′ and 57′ of FIG. 16 and subtracters 56′, 57′ and 88′ of FIG. 17 may also be each replaced by this signal selector circuit 90, provided that play synchronization pulses for deceleration control of the capstan motors are input over the line 93.

### POSSIBLE MODIFICATIONS

Despite the foregoing detailed disclosure it is not desired that the present invention be limited by the exact showings of the drawings or by the description thereof. The following is a brief list of possible modifications, alterations and adaptations which are all intended in the illustrated embodiments and so believed to fall within the scope of the invention:

1. The play synchronizer 3 could be integrated with the two VTRs 1a and 1b in the FIG. 1 video player system.

2. The play synchronizer 3′ could also be integrated with the three VTRs 1a-1c in the FIG. 10 video player system.

3. The play synchronizer 3 could be built into each of the two VTRs 1a and 1b in the FIG. 1 system, and the play synchronizer of either VTR used for play synchronization of both VTRs.

4. The play synchronizer 3′ could also be built into each of the three VTRs 1a-1c in the FIG. 10 system, and the play synchronizer of either VTR used for play synchronization of the VTRs.

5. The adders 56 and 57 of the FIG. 5 play synchronization circuit 43, the adders 56, 57 and 88 of the FIG. 12 circuit 43′, the subtracters 56′ and 57′ of the FIG. 16 circuit 43b, and the subtracters 56′, 57′ and 88′ of the FIG. 17 circuit 43c could be built into the capstan motor driver circuits of the VTRs 1a-1c, with the switches, such as those shown at 69a and 69b in FIG. 4, omitted.

6. In the FIGS. 5 and 16 play synchronization circuit 43 and 43′, the outputs from the flip-flops 54 and 55 could be directed into the adders 56 and 57, or subtracters 56 and 57, via integrating circuits or lowpass filters.

7. In the FIGS. 12 and 17 play synchronization circuits 43′ and 43c, too, the outputs from the AND gates 85-87 or 85′-87′ could be directed into the adders 56-58, or subtracters 56′-58′, via integrating circuits or lowpass filters.

8. In the FIGS. 10-15 embodiment, as in the FIGS. 1-9 embodiment, the vertical sync pulses Vs₁- Vs₃ could be allowed through the AND gates 71, 72 and 73 only when the tape ends are not detected during operation in play mode.

9. The invention could be applied to play synchronization of four or more VTRs.

10. The invention could be applied to synchronization of various videodisk players, in which application the speed of the videodisk drive motor, or the readout speed of the buffer memory on the input side of the digital-to-analog converter of the videodisk playback circuit, may be controlled by the outputs from, for instance, the flip-flops 54, 55 and 70.

What is claimed is:

1. A synchronizer for compulsorily synchronizing a plurality of video players for simultaneous display of as many correlated pictures, each video player being for use with a video storage medium on which there is stored a video signal including a series of vertical sync pulses, the synchronizer comprising:
(a) a plurality of vertical sync pulse separator circuits to be connected one to each video player for separating a series of vertical sync pulses from a video signal being recovered from a video storage medium;
(b) a reference moment determination circuit connected to the vertical sync pulse separator circuits for determination of a reference moment in prescribed time relationship to each vertical sync pulse of one selected series of such pulses being supplied from either of the vertical sync pulse separator circuits; and
(c) a play synchronization circuit connected to the vertical sync pulse separator circuits and the reference moment determination circuit for production of a plurality of phase departure signals each indicative of a phase departure, if any, of each vertical sync pulse of one series of such pulses from the reference moment determined in relation to one associated vertical sync pulse of the selected series of such pulses, the phase departure signals being for delivery one to each video player for causing the video players to produce the series of vertical sync pulses in phase with each other.

2. The video player synchronizer of claim 1 wherein the reference moment determination circuit is adapted to determine the reference moments in prescribed time relationship to the series of vertical sync pulses that is most advanced in phase.

3. The video player synchronizer of claim 1 wherein the reference moment determination circuit is adapted to determine the reference moments in prescribed time relationship to the series of vertical sync pulses that is most delayed in phase.

4. The video player synchronizer of claim 1 wherein the video signal contains one vertical sync pulse per field, and wherein the reference moment determination circuit is adapted to determine the reference moment at the trailing edge of each pulse of that series of vertical sync pulses which is most delayed in phase.

5. The video player synchronizer of claim 1 wherein the play synchronization circuit comprises a plurality of D flip-flops each having a clock input connected to one vertical sync pulse separator circuit, a data input connected to a supply terminal, a reset input connected to the reference moment determination circuit, and an output to be connected to one video player for delivery of one phase departure signal thereto.

6. The video player synchronizer of claim 5 wherein the reference moment determination circuit has inputs connected to the outputs of the flip-flops of the play synchronization circuit for determination of the reference moment in response to outputs therefrom.

7. The video player synchronizer of claim 1 wherein each video player has drive means for creating relative scanning motion between the video storage medium and a transducer under the control of a servo signal, and wherein the synchronizer further comprises output means for delivery of one phase departure signal and one servo signal to each video player.

8. The video player synchronizer of claim 1 further comprising a status judgment circuit whereby the synchronizer is permitted to synchronize the video players only when all the video players are in play mode.

9. The video player synchronizer of claim 1 further comprising means for permitting the play synchronization circuit to produce the phase departure signals for delivery to only those video players which are in play mode.

10. A synchronizer for compulsorily synchronizing a first and a second video player for simultaneous display of correlated pictures, each video player being for use with a video storage medium on which there is stored a video signal including a series of vertical sync pulses, the synchronizer comprising:
(a) a first vertical sync pulse separator circuit to be connected to a first video player for separating a first series of vertical sync pulses from a first video signal being recovered from a first video storage medium;
(b) a second vertical sync pulse separator circuit to be connected to a second video player for separating a second series of vertical sync pulses from a second video signal being recovered from a second video storage medium;
(c) a reference moment determination circuit connected to the first and the second vertical sync pulse separator circuit for determination of a reference moment in prescribed time relationship to each vertical sync pulse of a selected one of the first and the second series of such pulses being supplied from the first and the second vertical sync pulse separator circuit; and
(d) a play synchronization circuit comprising a first and a second D flip-flop having clock inputs connected respectively to the first and the second vertical sync pulse separator circuit, reset inputs connected to the reference moment determination circuit, and data inputs connected to a supply terminal, for production of a first phase departure signal indicative of a phase departure, if any, of each vertical sync pulse of the first series from the reference moment determined in relation to one associated vertical sync pulse of the selected series, and a second phase departure signal indicative of a phase departure, if any, of each vertical sync pulse of the second series from the reference moment determined in relation to one associated vertical sync pulse of the selected series, the first and the second phase departure signal being for delivery to the first and the second video player, respectively, for causing the same to synchronize the first and the second series of vertical sync pulses.

11. The video player synchronizer of claim 10 wherein the reference moment determination circuit comprises:
(a) an OR gate having inputs connected respectively to the first and the second vertical sync pulse separator circuit;
(b) a NOR gate having inputs connected respectively to the first and the second flip-flop of the play synchronization circuit; and
(c) a D flip-flop having a clock input connected to the OR gate, a data input connected to the NOR gate, and an output connected to the reset inputs of the first and the second flip-flop of the play synchronization circuit.

12. The video player synchronizer of claim 10 wherein the first and the second video player have drive means for creating relative scanning motion between the video storage medium and a transducer under the control of a first and a second servo signal, respectively, and wherein the play synchronization circuit of the synchronizer further comprises:
(a) a first adder having one input connected to the output of the first flop-flop, another input to be connected to the second video player for inputting the second servo signal, and an output to be connected to the drive means of the second video player; and
(b) a second adder having one input connected to the output of the second flip-flop, another input to be connected to the first video player for inputting the first servo signal, and an output to be connected to the drive means of the first video player.

13. The video player synchronizer of claim 10 wherein the first and the second video player have drive means for creating relative scanning motion between the video storage medium and a transducer under the control of a first and a second servo signal, respectively, and wherein the play synchronization circuit of the synchronizer further comprises:
(a) a first subtracter having one input connected to the output of the first flop-flop, another input to be connected to the first video player for inputting the first servo signal, and an output to be connected -to the drive means of the first video player; and
(b) a second subtracter having one input connected to the output of the second flip-flop, another input to be connected to the second video player for inputting the second servo signal, and an output to be connected to the drive means of the second video player.

14. The video player synchronizer of claim 10 wherein the play synchronization circuit further comprises:
(a) a first logic circuit having inputs connected to the first and the second flip-flop for passing all output pulses thereof;
(b) a second logic circuit having inputs connected to the first flip-flop and the first logic circuit for producing a pulse when an inversion of the output from the first flip-flop is of the same binary state as the output from the first logic circuit; and
(c) a third logic circuit having inputs connected to the second flip-flop and the first logic circuit for producing a pulse when an inversion of the output from the second flip-flop is of the same binary state as the output from the first logic circuit.

15. The video player synchronizer of claim 14 wherein the reference moment determination circuit comprises a fourth logic circuit having inputs connected respectively to the first and the second flip-flop of the play synchronization circuit, and an output connected to the reset input of the first and the second flip-flop of the play synchronization circuit, for resetting the first and the second flip-flops upon simultaneous production of pulses by the first and the second flip-flops.

16. The video player synchronizer of claim 14 wherein the first and the second video player have drive means for creating relative scanning motion between the video storage medium and a transducer under the control of a first and a second servo signal, respectively, and wherein the play synchronization circuit of the synchronizer further comprises:
(a) a first adder having one input connected to the second logic circuit, another input to be connected to the first video player for inputting the first servo signal, and an output to be connected to the drive means of the first video player; and
(b) a second adder having one input connected to the third logic circuit, another input to be connected to the second video player for inputting the second servo signal, and an output to be connected to the drive means of the second video player.

17. A synchronizer for compulsorily synchronizing a first, a second and a third video player for simultaneous display of correlated pictures, each video player being for use with a video storage medium on which there is stored a video signal including a series of vertical sync pulses, the synchronizer comprising:
(a) a first vertical sync pulse separator circuit to be connected to a first video player for separating a first series of vertical sync pulses from a first video signal being recovered from a first video storage medium;
(b) a second vertical sync pulse separator circuit to be connected to a the second video player for separating a second series of vertical sync pulses from a second video signal being recovered from a second video storage medium;
(c) a third vertical sync pulse separator circuit to be connected to a third video player for separating a third series of vertical sync pulses from a third video signal being recovered from a third video storage medium;
(d) a reference moment determination circuit connected to the first and the second and the third vertical sync pulse separator circuit for determination of a reference moment in prescribed time relationship to each vertical sync pulse of a selected one of the first and the second and the third series of such pulses being supplied from the first and the second and the third vertical sync pulse separator circuit; and
(e) a play synchronization circuit comprising a first and a second and a third D flip-flop having clock inputs connected respectively to the first and the second and the third vertical sync pulse separator circuit, reset inputs connected to the reference moment determination circuit, and data inputs connected to a supply terminal, for production of a first phase departure signal indicative of a phase departure, if any, of each vertical sync pulse of the first series from the reference moment determined in relation to one associated vertical sync pulse of the selected series, a second phase departure signal indicative of a phase departure, if any, of each vertical sync pulse of the second series from the reference moment determined in relation to one associated vertical sync pulse of the selected series, and a third phase departure signal indicative of a phase departure, if any, of each vertical sync pulse of the third series from the reference moment determined in relation to one associated vertical sync pulse of the selected series, the first and the second and the third phase departure signal being for delivery to the first and the second and the third video player, respectively, for causing the same to synchronize the first and the second and the third series of vertical sync pulses.

18. The video player synchronizer of claim 17 wherein the play synchronization circuit further comprises:
(a) a first logic circuit having inputs connected to the first and the second and the third flip-flop for passing all output pulses thereof;
(b) a second logic circuit having inputs connected to the first flip-flop and the first logic circuit for producing a pulse when an inversion of the output from the first flip-flop is of the same state as the output from the first logic circuit;
(c) a third logic circuit having inputs connected to the second flip-flop and the first logic circuit for producing a pulse when an inversion of the output from the second flip-flop is of the same binary state as the output from the first logic circuit; and
(d) a fourth logic circuit having inputs connected to the third flip-flop and the first logic circuit for producing a pulse when an inversion of the output from the second flip-flop is of the same binary state as the output from the first logic circuit.

19. The video player synchronizer of claim 18 wherein the reference moment determination circuit comprises a fifth logic circuit having inputs connected respectively to the first and the second and the third flip-flop of the play synchronization circuit, and an output connected to the reset input of the first and the second and the third flip-flop of the play synchronization circuit, for resetting the first and the second and the third flip-flop upon simultaneous production of pulses by the first and the second and the third flip-flop.

20. The video player synchronizer of claim 18 wherein the first and the second and the third video player have drive means for creating relative scanning motion between the video storage medium and a transducer under the control of a first and a second and a third servo signal, respectively, and wherein the play synchronization circuit of the synchronizer further comprises:
(a) a first adder having one input connected to the second logic circuit, another input to be connected to the first video player for inputting the first servo signal, and an output to be connected to the drive means of the first video player;
(b) a second adder having one input connected to the third logic circuit, another input to be connected to the second video player for inputting the second servo signal, and an output to be connected to the drive means of the second video player; and
(c) a third adder having one input connected to the fourth logic circuit, another input to be connected to the third video player for inputting the third servo signal, and an output to be connected to the drive means of the third video player.

21. The video player synchronizer of claim 17 wherein the first and the second and the third video player have drive means for creating relative scanning motion between the video storage medium and a transducer under the control of a first and a second and a third servo signal, respectively, and wherein the play synchronization circuit of the synchronizer further comprises:
(a) a first subtracter having one input connected to the output of the first flop-flop, another input to be connected to the first video player for inputting the first servo signal, and an output to be connected to the drive means of the first video player;
(b) a second subtracter having one input connected to the output of the second flip-flop, another input to be connected to the second video player for inputting the second servo signal, and an output to be connected to the drive means of the second video player; and
(c) a third subtracter having one input connected to the output of the third flop-flop, another input to be connected to the third video player for inputting the third servo signal, and an output to be connected to the drive means of the third video player.

22. A video player system for synchronous display of a plurality of correlated pictures, comprising:
(a) a display;
(b) a plurality of video players for recovering from video storage media a set of correlated video signals for joint visual presentation on the display, each video signal including a series of vertical sync pulses;
(c) a plurality of vertical sync pulse separator circuits connected one to each video player for separating the series of vertical sync pulses from the video signals being recovered from the video storage media;
(d) a reference moment determination circuit connected to the vertical sync pulse separator circuits for determination of a reference moment in prescribed time relationship to each vertical sync pulse of one selected series of such pulses being supplied from one of the vertical sync pulse separator circuits;
(e) a play synchronization circuit connected to the vertical sync pulse separator circuits and the reference moment determination circuit for production of a plurality of phase departure signals each indicative of a phase departure, if any, of each vertical sync pulse of one series of such pulses from the reference moment determined in relation to one associated vertical sync pulse of the selected series of such pulses; and
(f) drive means in each video player for creating relative scanning motion between a transducer and the video storage medium, the drive means being connected to the play synchronization circuit for reducing the phase departure of the vertical sync pulse from the reference moment in response to one phase departure signal from the play synchronization circuit.

23. The video player system of claim 22 further comprising:
(a) a controller in each video player for providing a servo signal for servo control of the drive means; and
(b) an adder having an input connected to the play synchronization circuit and another input connected to the controller of each video player for supplying an addition of one phase departure signal and one servo signal to the drive means of each video player.

24. The video player system of claim 22 further comprising:
(a) a controller in each video player for providing a servo signal for servo control of the drive means; and
(b) a subtracter having an input connected to the play synchronization circuit and another input connected to the controller of each video player for supplying a difference of one phase departure signal and one servo signal to the drive means of each video player.

25. The video player system of claim 22 further comprising:
(a) a controller in each video player for providing a play command for the video player; and
(b) a status judgment circuit connected between the controllers of all the video players and the play synchronization circuit for permitting the latter to synchronize the video players only when all the video players are in play mode.

26. The video player system of claim 22 further comprising:
(a) a controller in each video player for providing a play command for the video player; and
(b) means connected between the controllers of the video players and the play synchronization circuit for permitting the latter to deliver the phase departure signals only to the drive means of those video players which are in play mode.
